(19) United States
(12) Patent Application Publication
(10) Pub. No.: US 2025/0036775 A1
(43) Pub. Date: Jan. 30, 2025

(54) CYBERSECURITY STRATEGY ANALYSIS MATRIX

(71) Applicant: LEVEL 6 HOLDINGS, INC., Mason, OH (US)

(72) Inventor: Kevin Jackson, Mason, OH (US)

(21) Appl. No.: 18/716,860

(22) PCT Filed: Dec. 6, 2022
(86) PCT No.: PCT/US2022/051943

§ 371 Date: Jun. 5, 2024

Related U.S. Application Data
(60) Provisional application No. 63/286,365, filed on Dec. 6, 2021.

(51) Int. Cl. G06F 21/57

(52) U.S. Cl. CPC G06F 21/577; G06F 2221/034

(57) ABSTRACT

A business poly-intelligence application enabling the secure collection, warehousing, analysis, and reporting of manually shared and publicly sourced business strategy data is presented with systems, methods, and computer-readable media with a specific focus on crowdsourced cybersecurity strategy development.

### CROSS-REFERENCE TO RELATED APPLICATIONS

This application is claims the benefit of U.S. Patent Application No. 63/286,365, entitled “Cybersecurity Strategy Analysis Matrix”, filed Dec. 6, 2021, the entire contents of which are hereby expressly incorporated herein by reference.

### TECHNICAL FIELD

The present disclosure relates generally to the fields of crowdsourced knowledge, online data mining, big data analytics, data analytics, data analytics visualizations, business management, information security, information security strategy, and business management strategy.

### BACKGROUND

Data analytics and the more common application of data analytics to strategic business management (known as business intelligence) are increasingly adopted as critical decision support tools around the world. Over the past twenty years, business intelligence has evolved from being a niche-but-powerful concept used by the largest businesses to its current status as a standard component or operational goal across nearly every industry and within companies of every size. Among the many drivers of business intelligence and data analytics' explosive growth are the increases in computing power available for data processing, improvements in data processing algorithms (such as artificial intelligence and machine learning), improvements in data visualizations and reporting, and the data analytics industry's shift toward self-service analysis capabilities that lower the entry bar for smaller companies that lack data scientists.

Under the best circumstances, modern companies invest in business intelligence initiatives to create enterprise-wide data analytics environments where internal and external data sources may be combined and processed for decision support and strategic planning. Analysis of data trends in areas such as sales, finance, operations, human resources, capital and operations spending, accounts receivable, and marketing allows corporate executives to base their strategic plans and tactical decisions on enterprise data instead of on intuition and/or general industry best practices.

But there is gap in the application of business intelligence capabilities beyond the scope of any single business. There is no established way for companies to access what could be called “poly-intelligence”, the results of collecting data from many companies in a given industry vertical and conducting BI-like analytics to determine best practices, enterprise strategies, and specific tactics based on real-world results. Tens of thousands of companies worldwide collect useful data on their operations, but these data are only analyzed locally within each enterprise.

### SUMMARY

In accordance with the principles of the present disclosure, methods and systems are provided herein for the following aspects of the disclosure:

In some embodiments, a computer-implemented method for analyzing cybersecurity data may be provided. The method may be implemented via one or more local or remote processors, networks, servers, memory units, and/or other electronic or electrical components. In some instances, the method may include: (1) anonymously gathering and/or parameterizing manually-shared multi-enterprise cybersecurity/business strategy (cybersecurity best practices) data and cyber program outcomes; (2) gathering and/or parameterizing manually-shared, attributed cybersecurity/business strategy (cybersecurity best practices) data and cyber program outcomes from individual organizations; (3) autonomously and/or manually gathering and/or parameterizing multi-source academic research data on cybersecurity best practices and outcomes; (4) autonomously gathering and/or parameterizing open internet data on cybersecurity program design and implementation (best practices) and cyber program outcomes; (5) categorizing, transforming, and storing the data retrieved as a result of any of the foregoing steps in a common data warehouse; (6) categorizing, transforming, and/or storing the data retrieved as a result of any of the foregoing steps in a data warehouse; (7) performing business poly-intelligence analytics upon data resulting from any of the foregoing steps using descriptive and predictive analysis algorithms via business intelligence tools and proprietary analytic algorithms; (8) performing business intelligence analytics upon data resulting from any of the foregoing steps using descriptive and predictive analysis algorithms via business intelligence tools and proprietary analytic algorithms; (9) delivering analytic results in the form of reports and/or data visualizations as a result of analyses performed to provide insights into the relative strengths of an organization's cyber strategy current state and decision support/recommendations on domain-specific cyber strategy improvements; and/or (10) delivering analytic results in the form of reports and/or data visualizations as a result of analyses performed to provide threat-based predictive cyber strategy recommendations and decision support.

The foregoing aspects reflect a variety of the embodiments explicitly contemplated by the present application. Those of ordinary skill in the art will readily appreciate that the aspects below are neither limiting of the embodiments disclosed herein, nor exhaustive of all of the embodiments conceivable from the disclosure above, but are instead meant to be exemplary in nature.

These aspects may combine to create methods and systems for an end-to-end information lifecycle capability that transforms cybersecurity strategy plans and outcomes from many sources into descriptive and predictive analytic results for optimal (from both a security and financial perspective) cybersecurity program design and program efficacy evaluation for various enterprises and organizations.

Additionally, these aspects may also combine to create methods and systems for an end-to-end information lifecycle capability that transforms cybersecurity strategy plans and outcome histories from individual organizations into descriptive and predictive analytic results for optimal (from both a security and financial perspective) cybersecurity program design.

Finally, these aspects may also combine to create methods and systems for an end-to-end information lifecycle capability that transforms cybersecurity threat trends into descriptive and predictive analytic results for strategic cybersecurity program decision support (considering both security and financial aspects) in response to threat evolution.

### BRIEF DESCRIPTION OF THE DRAWINGS

Features and advantages of the present disclosure will become apparent to those skilled in the art from the following description with reference to the drawings, in which:

FIG. 1 shows an overall view of the end-to-end information lifecycle from multi-part source system data retrieval and processing to analytic result/visualization delivery to external parties.

FIG. 2 shows the architecture for autonomously and manually gathering multi-source cybersecurity program design and outcome academic research data and integrating said data into a data warehouse.

FIG. 3 shows the architecture for autonomously gathering open internet data on cybersecurity program design outcomes and integrating said data into a data warehouse.

FIG. 4 shows the architecture for anonymously gathering manually shared multi-organization (government and corporate) cybersecurity/business strategy and cyber program operational results data and integrating said data into a data warehouse.

FIG. 5 shows the architecture for gathering attributed, manually shared organizational (government and corporate) cybersecurity/business strategy and cyber program operational results data and storing said data into a secondary data warehouse.

FIG. 6 shows the architecture for leveraging the data warehouse to perform business poly-intelligence analytics using descriptive and predictive analysis algorithms via business intelligence tools and proprietary analytic algorithms to produce crowdsourced analytic results on cybersecurity strategy.

FIG. 7. shows the architecture for leveraging the secondary data warehouse to perform business intelligence analytics using descriptive and predictive analysis algorithms via business intelligence tools and proprietary analytic algorithms to produce individual organization analytic results on cybersecurity strategy.

FIG. 8 shows the architecture for leveraging crowdsourced analytic results within a reporting and visualization engine (supported by the business intelligence platform) to create cybersecurity strategy and insight deliverables tailored to specific information consumers.

FIG. 9 shows the architecture for leveraging individual organization analytic results within a reporting and visualization engine (supported by the business intelligence platform) to create cybersecurity strategy and optimization deliverables.

FIG. 10 shows the architecture for leveraging crowdsourced analytic results of threat data and threat trends within a reporting and visualization engine (supported by the business intelligence platform) to create cybersecurity strategy recommendations/alerts based on threat trends.

The figures described below depict various embodiments of the systems and methods disclosed herein. It should be understood that the figures depict illustrative embodiments of the disclosed systems and methods, and that the figures are intended to be exemplary in nature. Further, wherever possible, the following description refers to the reference numerals included in the following figures, in which features depicted in multiple figures are designated with consistent reference numerals.

There are shown in the drawings arrangements that are presently discussed, it being understood, however, that the present embodiments are not limited to the precise arrangements and instrumentalities shown. Further, the figures depict the present embodiments for purposes of illustration only. One skilled in the art will readily recognize from the following discussion that alternate embodiments of the structures and methods illustrated herein may be employed without departing from the principles of the invention described herein.

### DETAILED DESCRIPTION OF ILLUSTRATIVE EMBODIMENTS

The Cybersecurity Strategy Analysis Matrix (CSAM) is a system of systems that may provide an independent gathering place for parameterized cybersecurity best practices information and related cyber outcomes from multiple anonymous sources; academic research, the open internet (which may include news and social media sources), and organizations (companies and government bodies). This real-world cybersecurity strategy data may be stored in a data warehouse for analysis using data analytics (which may include artificial intelligence/machine learning) algorithms. The results of these analyses may include of the aforementioned business poly-intelligence information, correlations emerge between specific cybersecurity program decisions, and related best practices and specific cyber results. Trends emerge between particular plans, actions, technologies, operations, policies, and plans and actual cybersecurity results. In addition, cost data may be captured or calculated to represent the organizational investments that may be utilized to implement specific cybersecurity strategies. Simultaneously, negative cybersecurity outcomes (losses) may be captured or calculated. As a result, business poly-intelligence analytics may be used to actively calculate the return on investment (ROI) of specific cybersecurity strategies. Perhaps most powerfully, predictive analytics may provide insights into what is likely to occur given a given set of implemented cybersecurity program practices, and what the costs and associated ROI profiles of future investments might be.

These crowd-sourced analytic results may be arranged into business intelligence reports containing dashboards, scorecards, predictive outcome summaries, ROI summaries, and other outputs presented as data visualizations. These output products may provide databased insights to both general and specific cyber strategy questions and may provide cybersecurity planning information for questions no one knew to ask. These analytic reports may be made available to cybersecurity support organizations, corporations, and government organizations to provide never-before-seen databased decision support in the war against cyber attackers. In addition, these reports may provide data analytics to support cybersecurity program evaluation and review from an efficacy and ROI perspective.

In addition to these crowd-sourced analytic products, the CSAM architecture may also support helping individual organizations better manage their own internal cybersecurity strategies based on their individual, internal cybersecurity practices and outcomes over time. For this capability, commercial and government organizations may provide the same parameterized cyber practices and outcomes information mentioned previously, but in this case there is no need for anonymity. This attributed cyber strategy information may remain segmented from any other input data and is accumulated over time in a separate data warehouse. From there, business poly-intelligence analytics using the aforementioned algorithms may be performed on the organization's data alone. The resulting trend analyses, correlation metrics, ROI estimates, predictive analytics, and other output products may be provided to the organization for using in their security optimization efforts. This capability, providing individualized cybersecurity strategy decision support to commercial and government organizations seeking to improve their security posture, is critical, among other systems and features described herein, to realizing optimized cybersecurity results.

Another aspect of the CSAM capability suite may involve the analysis of data from academic sources, public internet sources, and both public and private organizations regarding cybersecurity threat trends and correlations that relate to cybersecurity strategy. Based on data consumed from these input sources, the CSAM data warehouse may include accumulated information on cyber threat evolution historically and presently. The BI poly-intelligence capability may analyze these data points to search for correlations and trends related to specific industries and to specific cyber strategy alignment in order to produce predictive cyber threat alerts. These alerts may be designed to alert threat-focused customers to the optimal ways to shift their domain-specific cyber strategy characteristics to proactively address specific new threat trends before attackers strike, and may include cost/benefit analyses (ROI calculations) in support of final decision markers.

The present disclosure may provide an end-to-end information lifecycle that transforms cybersecurity strategy plans and outcomes from many sources into descriptive and predictive analytic results for optimal (from both a security and cost perspective) cybersecurity program design for various enterprises and organizations. Multiple communication protocols based on internet communication services, cloud-based data management techniques, business intelligence toolsets, and data warehousing/master data management technologies may be leveraged in the various aspects of the disclosure as described in the descriptions below.

An Overall View of the End-to-End Information Lifecycle from Multi-Part Source System Data Retrieval and Processing to Analytic Result and Visualization Delivery to External Parties.

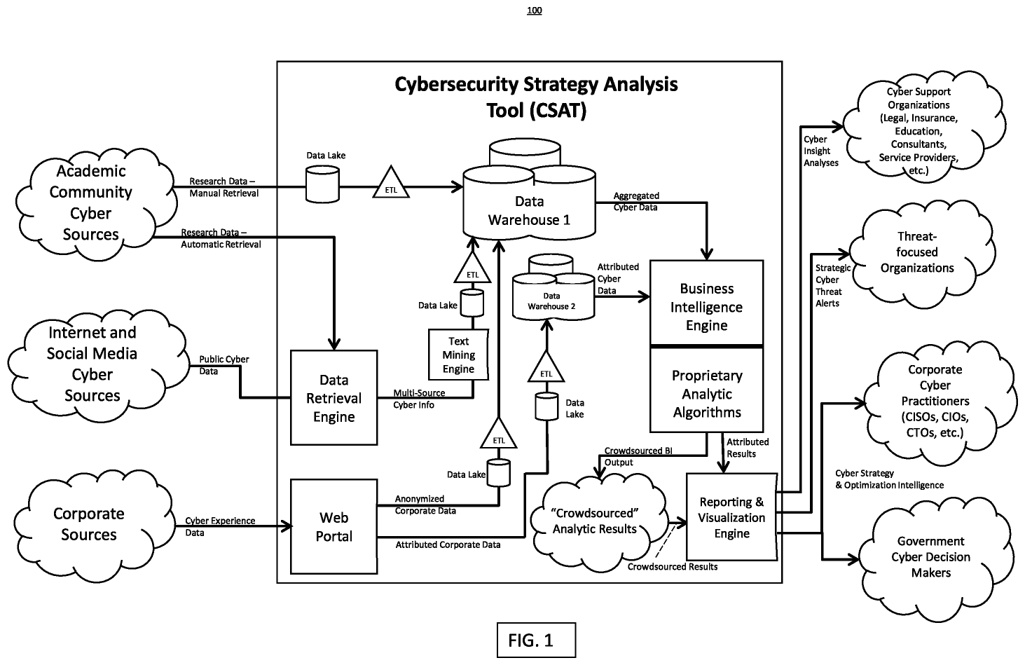

FIG. 1 depicts a summary view of the end-to-end information lifecycle proposed in the current disclosure. Note that the present disclosure is encapsulated within the block labeled “Cybersecurity Strategy Analysis Matrix (CSAM)”, and that in contrast the three symbols to the left of the block represent input source systems and the three symbols to the right of the block represent consumers of analytic results.

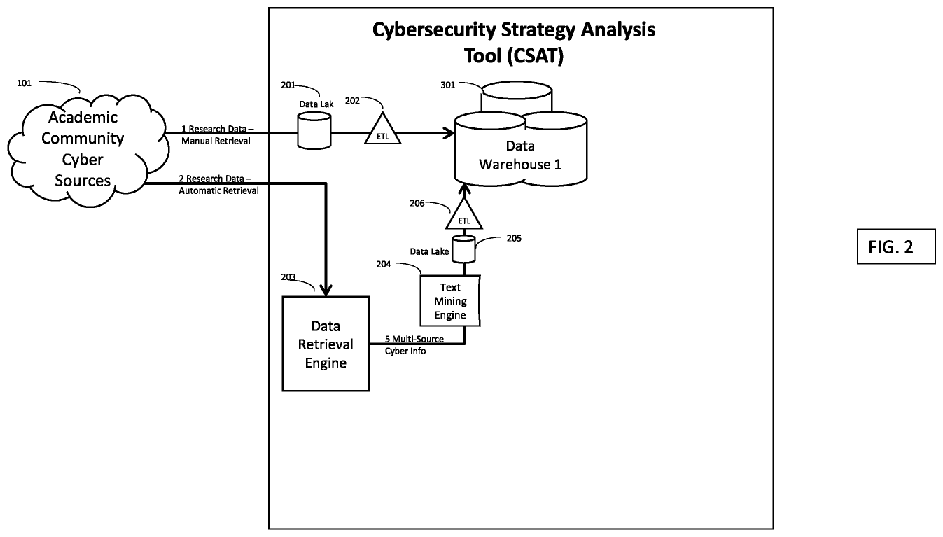

For details on the specific nature of each aspect of the current disclosure as depicted in FIG. 1, please reference the following detailed descriptions for FIG. 2-6.

Architecture for Autonomously and Manually Gathering Multi-Source Cybersecurity Program Design and Outcome Academic Research Data and Integrating Said Data into a Data Warehouse.

FIG. 2 depicts the first of three categories of poly-intelligence source systems for data retrieval and processing into the CSAM analytic architecture, the scholarly research data retrieval and processing path. There is an ever-expanding universe of peer-reviewed scholarly research into cybersecurity best practices and their outcomes that forms a readily available resource for poly-intelligence cybersecurity strategy analysis. The CSAM architecture supports the retrieval and processing of academic community cyber research data, the capture of research results across many different cybersecurity domains (see Table 1 for a list of in-scope cybersecurity domains) in temporary data lakes, and the transformation and loading of research data to a data warehouse for storage until needed for analytic processes.

TABLE 1
Cybersecurity Domains for CSAM Strategy Analytics

1. Program Administration & Planning
2. Policies, Plans, & Procedures Management
3. Identity & Access Management
4. Endpoint Protection
5. Perimeter/Cloud Protection
6. Network Security
7. Risk Management
8. Training
9. Data Governance
10. Email and Communications Security
11. Secure Business Continuity
12. Executive/Key Person Security
13. IT Disaster Recovery
14. Vulnerability Management
15. Incident Response
16. Mobile Device Management
17. Change and Configuration Management
18. Physical Cybersecurity
19. IT Asset Management
20. Monitoring & Log Management
21. Vendor Management
22. Secure Application Development
23. Internal Threat Modeling
Reserved for Future Use
Reserved for Future Use
Reserved for Future Use
Reserved for Future Use
Reserved for Future Use

Scholarly research sources in the Academic Community Cyber Sources 101 cloud may include EBSCO general and premium scholarly research databases, JSTOR scholarly research articles, and university-specific research collections from around the world. The nonhomogeneous nature of research products in the academic community leads to the bifurcated input path set depicted in FIG. 2; Step 1 “Research Data—Manual Retrieval” and Step 2.

“Research Data-Automatic Retrieval”. Note that Steps 1 and 2 of FIG. 2 may be asynchronous and, therefore, may occur at any time or simultaneously.

The Step 1 “Research Data-Manual Retrieval” input path from Academic Community Cyber Sources 101 may involve cybersecurity analysts manually entering relevant, cyber domain-specific best practices scholarly research information into tables for storage in a manual retrieval Data Lake 201. Cybersecurity research data captured within the Step 1 “Research Data—Manual Retrieval” input path may be unstructured and semi-structured data that is not suited for automatic retrieval and processing via the Data Retrieval Engine 203.

On a per-cyber domain basis, Step 1 data retrieval and processing from Academic Community Cyber Sources 101 to Data Lake 201 may occur in alignment with Table 2. Note that the Best Practices (BP) information elements in Table 2, marked with an asterisk, may include summary elements that are themselves made up of many domain-specific data elements captured in Table 3. Table 3 also may contain the BP Definition data collection. Table 4 defines the information elements for the related cybersecurity outcomes.

TABLE 2
General Information Elements

| Information | |
|---|---|
| Element/Category | Description |
| Cybersecurity Domain | Applicable domain identifier (per Table 1). |
| Research Type | Analytical approach leveraged (e.g. |
| | quantitative, qualitative, case study, etc.). |
| | Categorical/Not applicable. |
| Confidence Level | Reliability rating based on research variables |
| | (e.g. sample size, error margins, researcher |
| | confidence, etc.). Percentage/Not applicable. |
| Industry Alignment | Categorical. Relevant |
| | industries/organizational types. |
| Staff Structure (White | Percentages. |
| Collar, Intermediate, | |
| Blue Collar) | |
| Organization Size | Relevant high-level org and department/ |
| Alignment | group sizes. Numerical. |
| Number of Computer | Numerical |
| End Users | |
| Number of Mobile | Numerical |
| End Users | |
| *Best Practice (BP) | Collection domain-specific implementations/ |
| Design, Primary | configurations leading to a research |
| | outcome. See Table 3. |
| *BP Outcome, Primary | Domain-specific results of the primary BP. |
| *BP Design, Secondary | Collection domain-specific |
| (optional) | decisions/configurations leading to a |
| | secondary research outcome. See Table 3. |
| *BP Outcome, | Domain-specific results of the secondary BP. |
| Secondary (optional) | |
| *BP Design, Tertiary | Collection domain-specific |
| (optional) | decisions/configurations leading to a tertiary |
| | research outcome. See Table 3. |
| *BP Outcome, | Domain-specific results of the tertiary BP. |
| Tertiary (optional) | |

TABLE 3
BP Design Per-Domain Information Types

| Information | |
|---|---|
| Element/Category | Description |
| BP Identifier | Applicable Best Practice category identifier. |
| Role and Responsibility | The “who” of the BP implementation, |
| Identifier | title(s)/role(s) of organizational BP |
| | implementer(s). |
| BP Definition | Data field collection describing the specific |
| | BP implementation. The “what” of the BP. |
| Timeline Identifier | Duration and/or cadence identifier(s). The |
| | “when” or “how long” of the BP. |
| Location Identifier | Optional location information, capturing |
| | physical or logical BP implementation |
| | structure. The “where” of the BP. |
| Implementation | Data field collection capturing or calculating |
| Cost Data | the approximate costs of specific |
| | cybersecurity strategy decision set |
| | implementations. |

TABLE 4
BP Outcome Information Types

| Information | |
|---|---|
| Element/Category | Description |
| BP Identifier | Applicable Best Practice category identifier |
| | related to incident, if known. |
| Incident Type | Classification of cybersecurity incident. |
| Incident Rate | Classification of confirmed incident |
| | frequency within a specific timeframe. |
| Incident False | Percentage. |
| Alarm Rate | |
| Incident Timeframes | Timeframe for incident rate. |
| Incident Severity | Relative impact of specific confirmed |
| | incidents |
| Incident Direct Cost | Total cost of specific confirmed incidents, |
| | including staff hours, third-party services, and |
| | direct losses. |
| Incident Indirect Cost | Incident-related reputational damage or |
| | business losses for confirmed incidents. |
| Response Time | Measure of incident response initiation after |
| | initial alert for confirmed incidents. |
| Dwell Time | Measure of delay from incident cause to |
| | incident response initiation for confirmed |
| | incidents. |
| Response | Relative efficacy of response activities in |
| Effectiveness | mitigating incident severity, reducing |
| | response time/dwell time, or improving final |
| | outcomes. Percentage, per confirmed incident. |

The standardization of summarized research data may result within Data Lake 201 may provide the foundation for the continuation of Step 1 via extraction, transformation, and loading (ETL) 202 processing resulting in data loads to the Data Warehouse 301. The logic built into ETL 202, particularly the transformations that may be required to meet the analytic aspects of Business Intelligence Engine 302 and its proprietary analytic algorithms, supports the common master data architecture that may be required to integrate Step 1 research data retrieval and processing with the source system data provided via ETL 206 and 209. In other words, ETL 202, 206, and 209 may feature parallel design elements that support the common Data Warehouse 301 architecture despite being supplied by different source systems.

The Step 2 “Research Data-Automatic Retrieval” input path from Academic Community Cyber Sources 101 may involve Data Retrieval Engine 203 establishing electronic interfaces directly with research results databases within the academic community. Step 2 is therefore a multi-interface, multi-source system input path for unstructured research publications. Data Retrieval Engine 203, which may be configured to locate and accept completed and peer-reviewed cybersecurity academic research, may serve as a collection and routing point to manage the various Step 2 source systems and route the data through the Step 5 “Multi-Source Cyber Info” path to the Text Mining Engine 204. The Text Mining Engine 204 may be itself an instantiation of a data analytics tool similar to the Business Intelligence Engine 302, but with limited scope designed to perform textual analysis on the unstructured data collected.

The Text Mining Engine 204 may be configured to automatically identify and capture, to the greatest extent possible, the information elements in Tables 2, 3, and 4 from the research sources. The results may continue along the Step 5 “Multi-Source Cyber Info” path to Data Lake 205 for storage and both automatic and manual curation by data administrators. The data curation process may address any data quality issues resulting from Text Mining Engine 204's automated processing to complete data alignment with the information elements in Tables 2, 3, and 4.

Step 5 “Multi-Source Cyber Info” may continue from Data Lake 205 to ETL 206, previously described as featuring parallel design elements that support the common Data Warehouse 301 architecture. Data loads leveraging ETL 206 may populate Data Warehouse 301 via both automated and manually triggered loading processes.

The Step 2 “Research Data-Automatic Retrieval” input path from Academic Community Cyber Sources 101 may involve a search/web crawler-based Data Retrieval Engine 203 leveraging electronic interfaces to academic data sources to capture relevant, cyber domain-specific best practices scholarly research information. The nature of automatic search/web crawler-based data retrieval and processing may rely on the availability of semi-structured and structured research data results within academic research sources, but may also support the retrieval and processing of unstructured data.

Regardless of the level of structure, automatic data retrieval driven by Data Retrieval Engine 203, which may proceed through the Step 5 “Multi-Source Cyber Info” path, may be processed via the Text Mining Engine 204. The text mining engine may leverage standard and novel textual analytics to derive information elements aligned with Tables 2, 3, and 4.

Step 5 may continue with the Text Mining Engine 204 output information elements (aligned with Tables 2, 3, and 4) stored in Data Lake 205 (a mirror of Data Lake 201). As is the case in Step 1, Step 5 may culminate with the standardized research data results within the Data Lake 205 supporting extraction, transformation, and loading (ETL) 206 (a mirror of ETL 202) processing and loading into Data Warehouse 301.

Architecture for Autonomously Gathering Open Internet Data on Cybersecurity Program Design and Outcomes and Integrating Said Data into a Data Warehouse.

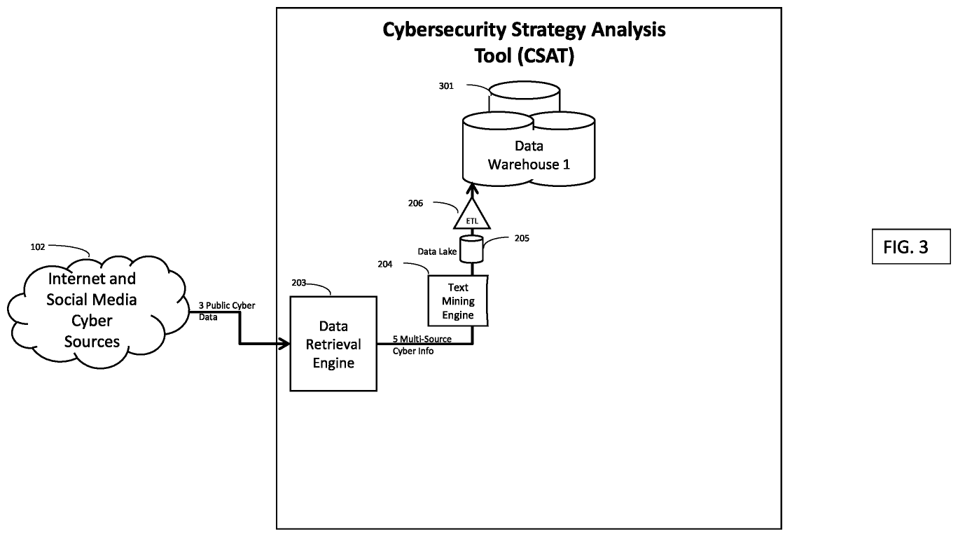

FIG. 3 depicts the second of three categories of poly-intelligence source systems for data retrieval and processing into the CSAM analytic architecture, the open internet data retrieval and processing path. The open internet data retrieval path is the most complex data retrieval and processing path since the vast range of internet publications, articles, blog posts, and social media discussions pose a tremendous challenge to any big data analytics pursuit and to relevant data quality maintenance. Allowing success in the management of this compound source system is, among other systems and features described herein, the configurable nature of Data Retrieval Engine 203 and the manual and automatic data curation processes established along the Step 5 “Multi-Source Cyber Info” path.

The CSAM architecture may support the retrieval and processing of open source intelligence (OSINT) cybersecurity and cyber strategy commentary, news articles, social media alerts, and general discussions from Internet and Social Media Cyber Sources 102 through the Step 3 “Public Cyber Data” path. The content of Step 3 “Public Cyber Data” may be unstructured cybersecurity practice information within which may include both positive and negative best practices architecture and outcome information as well as related implementation cost information. The capture of related cybersecurity best practice information from public sources may occur within Data Retrieval Engine 203 for each defined cybersecurity domain (see Table 1 for a list of in-scope cybersecurity domains). The nature and definition of accepted public cybersecurity source systems may be manually determined and configured by CSAM administrators and features incremental and iterative source identification and acceptance throughout the CSAM data lifecycle.

From that point forward, the data processing path may proceed to Step 5 “Multi-Source Cyber Info”.

Architecture for Anonymously Gathering Manually Shared Multi-Enterprise (Government and Corporate) Cybersecurity/Business Strategy and Cyber Program Operational Results Data and Integrating Said Data into a Data Warehouse.

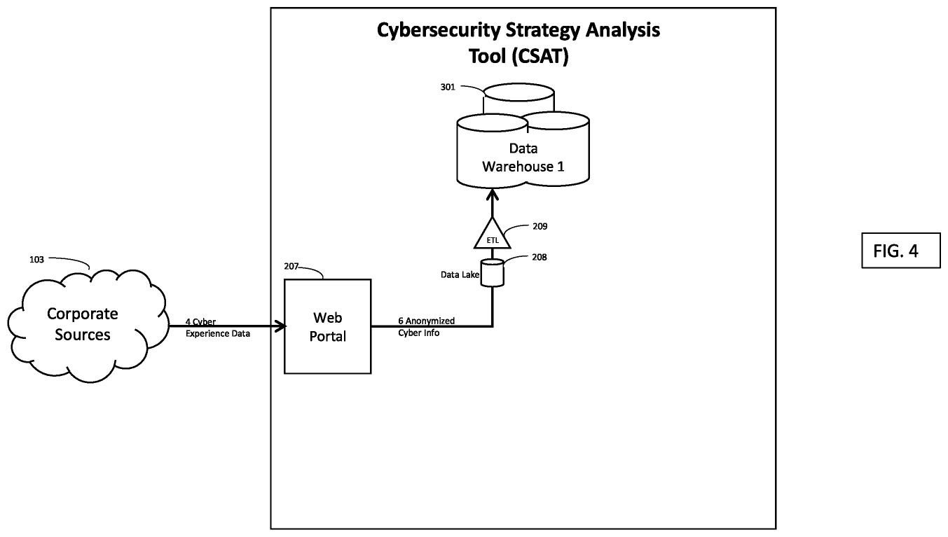

FIG. 4 depicts the third of three categories of poly-intelligence source systems for data retrieval and processing into the CSAM analytic architecture, the multi-enterprise cybersecurity/business strategy path. This is the Corporate Sources 103 data retrieval and processing path, where partner companies provide cybersecurity program design and outcome information destined for the Data Warehouse 301. Note that both public/governmental and private sector organizations may be included within the Corporate Sources 103 cloud.

This source system path may begin with the submission of Step 4 “Cyber Experience Data” from organizations within Corporate Sources 103 via CSAM-internal Web Portal 207. As with prior source systems, Step 4 “Cyber Experience Data” may be structured in alignment with the cybersecurity BP design and outcome information elements in Tables 2, 3, and 4. Web Portal 207 may be designed with both anonymity and security controls in place; no connecting corporate or organizational identifiers, logical or electronic, are stored within Step 6 “Anonymized Corporate Data”.

Web Portal 207 may feature end-to-end encryption via TLS 1.2 and organization-specific login access leveraging multi-factor authentication and session security management based on short-lived sessions. Cybersecurity best practice design and outcome (e.g., implementation costs and cybersecurity-related losses) data entry within the web portal may be accomplished via either wizard-based domain-by-domain manual entry or via upload of completed best practice.csv table/spreadsheet (which may be downloaded from the web portal's entry dashboard). Web Portal 207 also may feature progress tracking and email-based notifications for incomplete submissions, as well as automated email reminders requesting regular best practice design and outcome updates.

Data Lake 208, previously noted as being a structural mirror of Data Lakes 205 and 202, may store Step 6 “Anonymized Corporate Data”. As is the case with Steps 1 and 5, Step 6 may culminate with the anonymized corporate data within the Data Lake 208 being subject to extraction, transformation, and loading processes via ETL 209 (a mirror of ETL 206 and 202) with a final destination of the Data Warehouse 301.

Architecture for Gathering Attributed, Manually Shared Organizational (Government and Corporate) Cybersecurity/Business Strategy and Cyber Program Operational Results Data and Storing Said Data into a Secondary Data Warehouse.

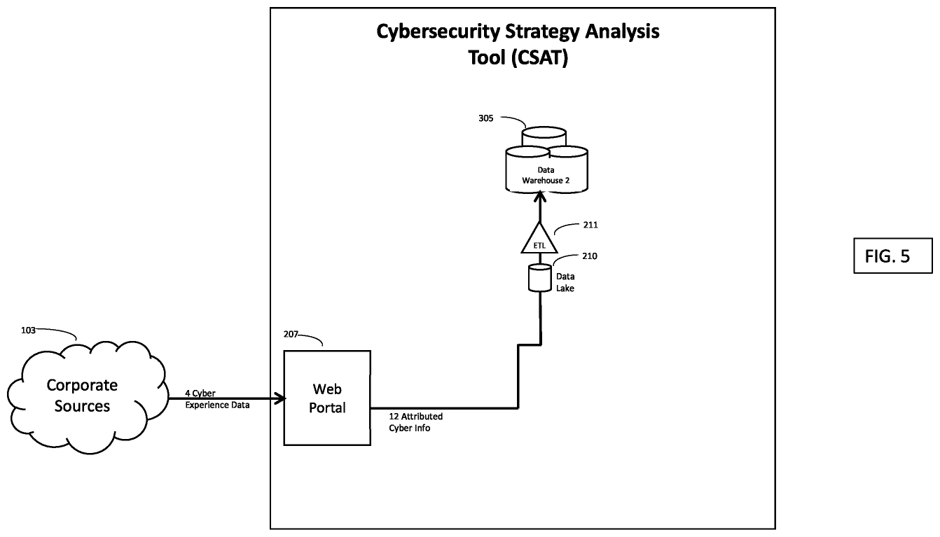

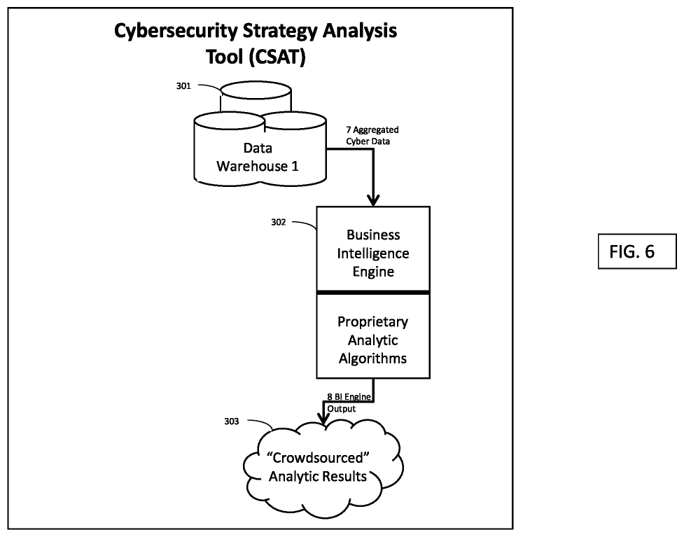

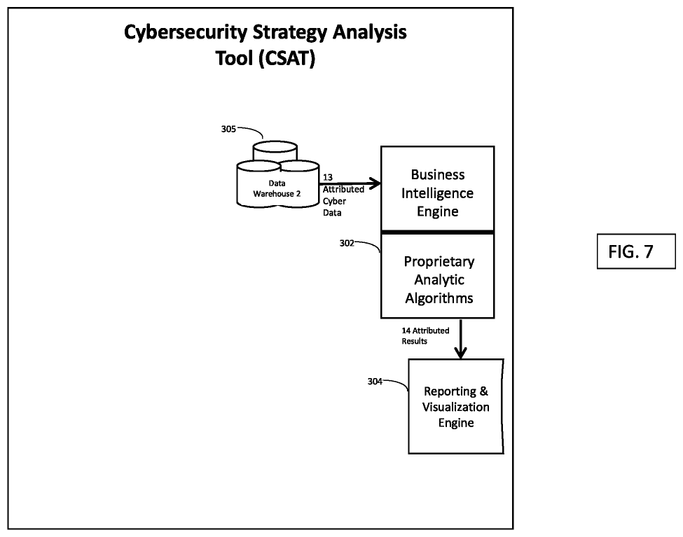

FIG. 5 depicts the fourth category for data retrieval and processing into the CSAM analytic architecture, the attributed data, internal analytics path. This is the attributed Corporate Sources 103 data retrieval and processing path, where organizations provide historical cybersecurity program design and outcome information (e.g., implementation costs and cybersecurity-related losses) without anonymity destined for the Data Warehouse 2 305. Note that both public/governmental and private sector organizations may be included within the Corporate Sources 103 cloud.

This source system path may begin with the submission of Step 4 “Cyber Experience Data” from organizations within Corporate Sources 103 via CSAM-internal Web Portal 207. As with prior source systems, Step 4 “Cyber Experience Data” may be structured in alignment with the cybersecurity BP design and outcome information elements in Tables 2, 3, and 4. In this case, however, the Web Portal 207 anonymity controls may be bypassed, and the organization-specific cyber program information may proceed along the Step 12 “Attributed Cyber Info” path. The other Web Portal 207 capabilities previously described may also apply here.

Data Lake 210, a structural mirror of Data Lakes 208, 205 and 202, may store Step 12 “Attributed Cyber Info”. This data may be subject to extraction, transformation, and loading processes via ETL 211 (a mirror of ETL 209, 206 and 202) with a final destination of the Data Warehouse 2 305.

Architecture for Leveraging the Data Warehouse to Perform Business Poly-Intelligence Analytics Using Descriptive and Predictive Analysis Algorithms Via Business Intelligence Tools and Proprietary Analytic Algorithms to Produce Crowdsourced Analytic Results on Cybersecurity Strategy.

For details on the specific nature of each aspect of the current invention as depicted in FIG. 1, please reference the following detailed descriptions for FIG. 2-6.

FIG. 6 depicts the CSAM design for the capture and storage of integrated cybersecurity best practices design and outcome data within Data Warehouse 301, as well has how the aggregated data is leveraged by poly-intelligence analytics to generate crowdsourced analytic results.

ETL 202, 206, and 209 may provide data loads to the Data Warehouse 301. Data Warehouse 301 may be a cloud-based, dynamic, multi-part data management system that may include both relational and dimensionally modeled components. The structure of the warehouse iteratively changes along with the adaptive nature of the detailed data elements as well as the summary information elements in Tables 2, 3, and 4. A strict data governance process and agile management approach are in place to maintain Data Warehouse 301 as a “source of truth” for CSAM analytics.

From the Data Warehouse 301, the Step 7 “Aggregated Cyber Data” path allows the Business Intelligence Engine 302 to request/extract specific datasets for analysis using proprietary analytic algorithms.

In some embodiments, the analytic algorithm type employed within Business Intelligence Engine 302 may be direct correlation computation based on simple and/or advanced regression analyses across the multidimensional surfaces from per-domain and cross-domain BP data elements and cybersecurity outcomes as defined in Table 4 (this analytic algorithm also may be described as a “descriptive analytic algorithm” herein). As the volume of data available in Data Warehouse 301 increases, strong and statistically significant correlations between best practices design and specific cyber outcome details emerge with increasing levels of correlation confidence.

In these embodiments, the cybersecurity outcomes as defined in Table 4 may be dependent variables and each of the multidimensional surfaces from per-domain and cross-domain BP data elements may be independent variables. A machine learning module may generate a machine learning model as an equation, which most closely approximates the cybersecurity outcomes as defined in Table 4 from the multidimensional surfaces from per-domain and cross-domain BP data elements. In some embodiments, an ordinary least squares method may be used to minimize the difference between the value of the guessed cybersecurity outcomes and the actual cybersecurity outcomes using the machine learning model.

Additionally, the differences between the values of each of the multidimensional surfaces from per-domain and cross-domain BP data elements (ŷᵢ) using the machine learning model and actual cybersecurity outcomes as defined in Table 4 (yᵢ) may be aggregated and/or combined in any suitable manner to determine a mean square error (MSE) of the regression. The MSE may be used to determine a standard error or standard deviation(s) in the machine learning model, which may in turn be used to create confidence intervals. For example, assuming the data is normally distributed, a confidence interval which may include about three standard deviations from the guessed cybersecurity outcomes using the machine learning model (ŷᵢ−3σ_{ε}−ŷᵢ+3σ_{ε}) may correspond to 99.5 percent confidence. A confidence interval which may include about two standard deviations from the recommended vehicle seat using the machine learning model (ŷᵢ-2σ_{ε}−ŷᵢ+2σ_{ε}) may correspond to 95 percent confidence. Moreover, a confidence interval which may include about 1.5 standard deviations from the recommended vehicle seat using the machine learning model (ŷᵢ−1.5σ_{ε}−ŷᵢ+1.5σ_{ε}) may correspond to 90 percent confidence.

In some other embodiments, the analytic algorithm type employed within Business Intelligence Engine 302 may be machine learning-based predictive analytics. More specifically, the accumulated data within Data Warehouse 301 may be used to train machine learning algorithms in support of decision modeling. The inputs from the various parameterized best practices may represent hundreds of specific decisions intended to generate specific outcomes. The outcome information, also parameterized, may be combined with the best practice inputs to train machine learning algorithms on the most likely outcomes aligned with the input decisions and investment profiles. Once again, as the volume of data available in Data Warehouse 301 increases the accuracy and confidence levels of decision model predictions increases.

The machine learning algorithms may also be tested to determine accuracy. In some embodiments, the testing data may be from the same collection of data as the training data. In these embodiments, the training data is divided into a ratio of training data and testing data (e.g., 20% training data and 80% testing data). Once divided, the training data generates the machine learning model and the testing data determines the accuracy of the model. When the machine learning module is correct more than a predetermined threshold amount, the machine learning model may be used for generating the specific outcomes. However, if the machine learning module is not correct more than the threshold amount, the machine learning module may continue obtaining sets of training data and/or testing data for further training and/or testing.

The aforementioned algorithms may be based on the application of Evidence-based Weighting (EBW) for specific factors in best practices design. EBW also may take into account non-parameterized inputs such as corporate culture information, source reliability, human factors issues in specific industries and organizational types, and other indirect factors discovered during source data evaluation and industry analysis. These EBW factors may be iteratively applied to both regression and decision modeling datasets to account for non-parameterized factors. The EBW impacts themselves are cross-analyzed against non-weighted input sets to increase the accuracy of the factors in future iterations. This allows the ever-evolving current state of individual organizational cybersecurity strategy, industry-level cybersecurity strategy, and general cybersecurity strategy to be more accurately reflected in the analytic results.

These analytic results may proceed through Step 8 “BI Engine Output”, flowing from Business Intelligence Engine 302 to Crowdsourced Analytic Results 303. Crowdsourced Analytic Results 303 may be a results repository within the BI stack for the storage of initial, intermediate, and final analytic results from regression and decision modeling activities within Business Intelligence Engine 302. Initial and intermediate results may be staged for re-analysis via the same or different analytical approaches or for iterative re-analysis using adapted EBW factors.

Architecture for Leveraging the Secondary Data Warehouse to Perform Business Intelligence Analytics Using Descriptive and Predictive Analysis Algorithms Via Business Intelligence Tools and Proprietary Analytic Algorithms to Produce Individual Organization Analytic Results on Cybersecurity Strategy.

FIG. 7 depicts the CSAM design for the capture and storage of individual organization cybersecurity best practices design and outcome data within Data Warehouse 2 305, as well has how the aggregated data is analyzed to generate organization-specific cyber strategy analytic results.

Data Warehouse 2 305, a structural mirror of Data Warehouse 301, may be a cloud-based, dynamic, multi-part data management system which may include both relational and dimensionally modeled components. The structure of the warehouse may iteratively change along with the adaptive nature of the detailed data elements as well as the summary information elements in Tables 2, 3, and 4. A strict data governance process and agile management approach may be in place to maintain Data Warehouse 2 305 as a “source of truth” for individual organization CSAM analytics.

From Data Warehouse 2 305, the Step 13 “Attributed Cyber Data” path may allow the Business Intelligence Engine 302 to request/extract specific datasets for analysis using proprietary analytic algorithms. Business Intelligence Engine 302 may leverage the same per-domain and cross-domain BP data elements and cybersecurity outcomes previously mentioned. As the volume of data available in Data Warehouse 2 305 increases, strong and statistically significant correlations between best practices design and specific cyber outcome details emerge with increasing levels of correlation confidence for specific organizations. Initial and intermediate results may be staged for re-analysis within Business Intelligence Engine 302 via the same or different analytical approaches or for iterative re-analysis. The other key capabilities previously described for Business Intelligence Engine 302 apply.

These analytic results may proceed through Step 14 “Attributed Results”, flowing from Business Intelligence Engine 302 to Reporting and Visualization Engine 304.

Architecture for Leveraging the Crowdsourced Analytic Results within a Reporting and Visualization Engine (Supported by the Business Intelligence Platform) to Create Cybersecurity Strategy and Insight Deliverables Tailored to Specific Information Consumers.

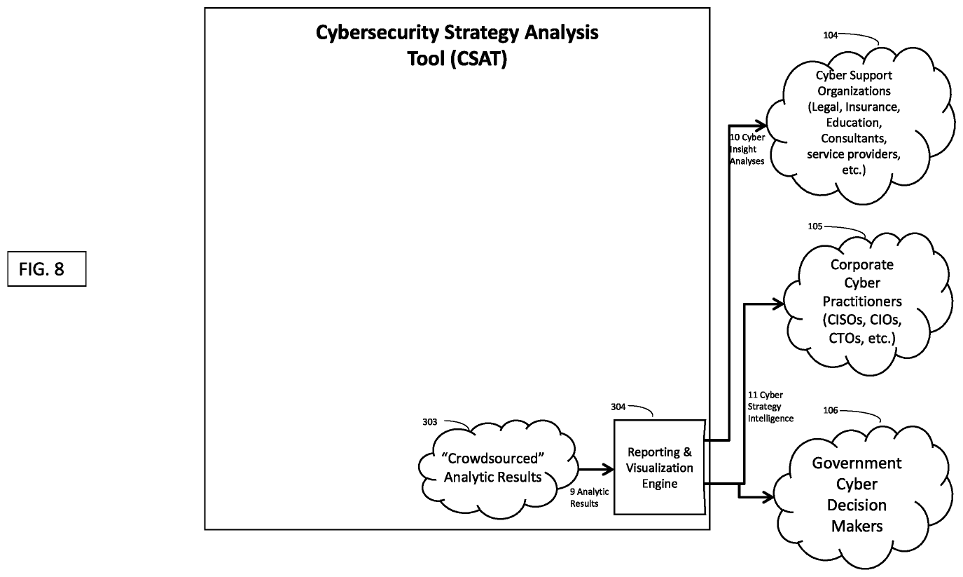

FIG. 8 depicts the CSAM design for leveraging the crowdsourced analytic results within a reporting and visualization engine to create cybersecurity strategy and insight deliverables tailored to specific information consumers.

Crowdsourced Analytic Results 303 may contain analytic results data that may require direct intervention by human cybersecurity strategy experts to validate and verify applicability and completeness before processing into cybersecurity strategy and insight deliverables. This cultivated set of outputs represent a core component of business poly-intelligence analyses performed by the CSAM invention.

After verification and validation, these cultivated output datasets may flow through the Step 9 “Analytic Results” path to Reporting and Visualization Engine 304. Cultivated output analytic results may be organized into many potential reporting and visualization types leveraging the visualization engine, based on both information consumer requests and on internal CSAM cybersecurity strategy expert directive. The reporting and visualization options may include dash boards, individual graphs and charts, scorecards, and narrative reports that may accompany visualizations, include visualizations, or may stand alone. Regardless of the medium, Reporting and Visualization Engine 304 may be leveraged to create organized summaries of trends, correlations, and predictions for cybersecurity strategy based on the many potential combinations of input best practices data from academic, open internet, and corporate sources.

A first type of output from Reporting and Visualization Engine 304 may be the Cyber Insight Analysis. Cyber Insight Analyses may proceed along the Step 10 “Cyber Insight Analyses” path to Cybersecurity Support Organizations 104. Cyber Insight Analyses may be not organization or company specific, but rather contain industry-specific, size-specific, and strategic approach-specific analytic results for use by organizations in need of increased clarity into the databased best practices approach in some or all of the 22 cybersecurity domains. The information consumers for Cyber Insight Analyses, Cybersecurity Support Organizations 104, may include law firms, insurance providers, educational/academic bodies, managed services providers, and perhaps most commonly organizations that provide cybersecurity consulting to multiple other independent organizations.

A second type of output from Reporting and Visualization Engine 304 may be Cyber Strategy & Optimization Intelligence. Cyber Strategy & Optimization Intelligence may proceed along the Step 11 “Cyber Strategy & Optimization Intelligence” path to Corporate Cyber Practitioners 105 and Government Cyber Decision Makers 106. Cyber Strategy & Optimization Intelligence may be much more specific than Cyber Insight Analyses and may provide detailed analytic results and visualizations for specific organizations based on their alignment with cybersecurity strategy best practices, calculated cybersecurity strategy ROI, and the analytic results/predictions from the CSAM process. In many cases, Cyber Strategy & Optimization Intelligence may provide answers to specific strategic questions posed by Corporate Cyber Practitioners 105 and Government Cyber Decision Makers 106 information consumers. In others, CSAM cyber strategy experts proactively determine critical correlations or predictions and offer the corresponding results and visualizations to these information consumers.

The delivery of all three categories of output products via Step 10 “Cyber Insight Analyses” and Step 11 “Cyber Strategy & Optimization Intelligence” may be cyclical, iterative, and/or recursive in nature, reflecting the every-changing nature of cybersecurity best practices and their real-world outcomes in the many different sizes and types of organizations worldwide. Also note that, by design, many of the entities acting as information consumers in Cybersecurity Support Organizations 104, Corporate Cyber Practitioners 105, and Government Cyber Decision Makers 106 may be the same entities providing input to the CSAM process within Academic Community Cyber Sources 101 and Corporate Sources 103.

Architecture for Leveraging Individual Organization Analytic Results within a Reporting and Visualization Engine (Supported by the Business Intelligence Platform) to Create Cybersecurity Strategy and Optimization Deliverables.

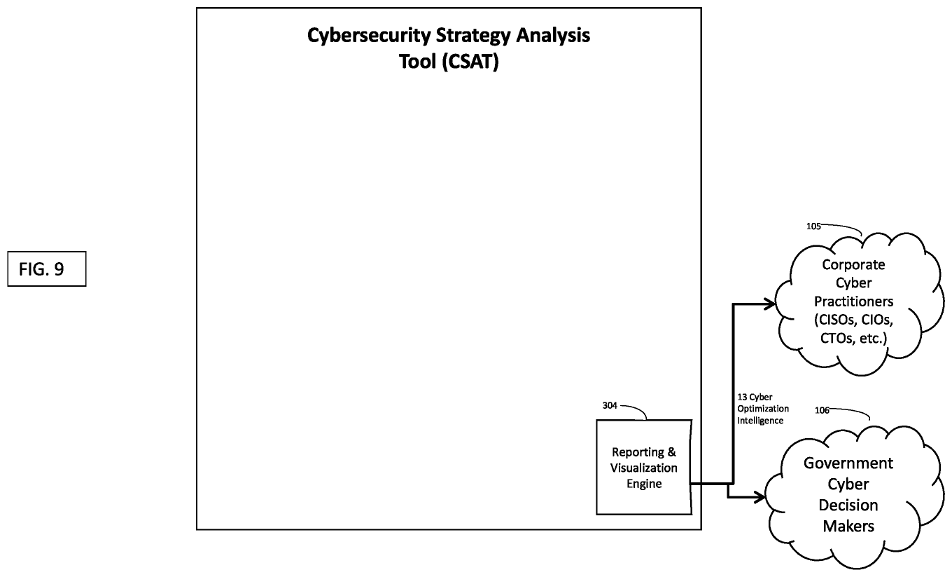

FIG. 9 depicts the CSAM design for leveraging individual organization analytic results within a reporting and visualization engine to create cybersecurity strategy and optimization deliverables for each organization.

Crowdsourced Analytic Results 303 contains analytic results data that may require direct intervention by human cybersecurity strategy experts to validate and verify applicability and completeness before processing into cybersecurity strategy and insight deliverables. This cultivated set of outputs represent a core component of business poly-intelligence analyses performed by the CSAM invention.

Reporting and Visualization Engine 304 may be leveraged as previously described but for individual organizations. The output products for individual organizations may include the Step 13 “Cyber Optimization Intelligence” flowing to Corporate Cyber Practitioners 105 and Government Cyber Decision Makers 106. As with other reports previously defined, Step 13 “Cyber Optimization Intelligence” may be cyclical, iterative, and/or recursive in nature, reflecting the every-changing nature of cybersecurity best practices and their real-world outcomes within each individual organization.

Architecture for Leveraging Crowdsourced Analytic Results of Threat Data and Threat Trends within a Reporting and Visualization Engine (Supported by the Business Intelligence Platform) to Create Cybersecurity Strategy Recommendations/Alerts Based on Threat Trends.

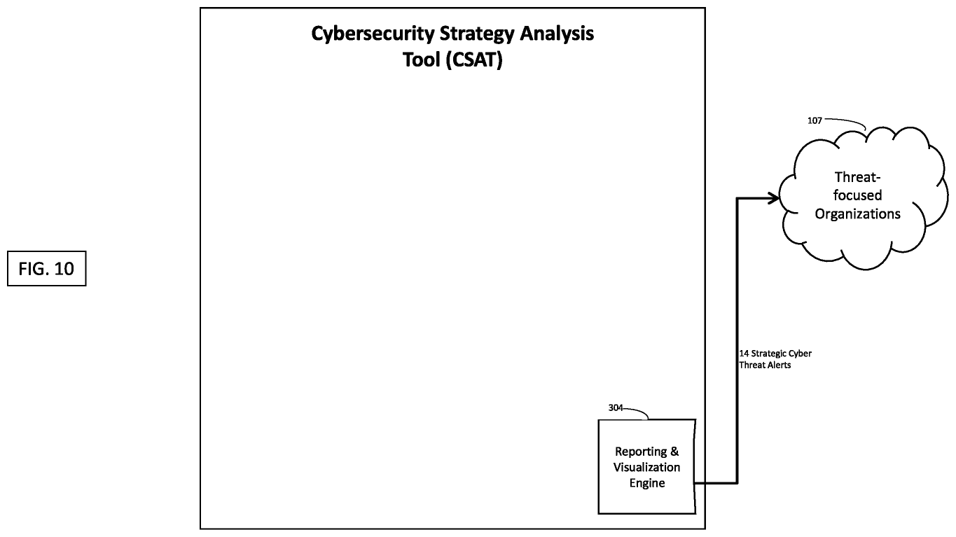

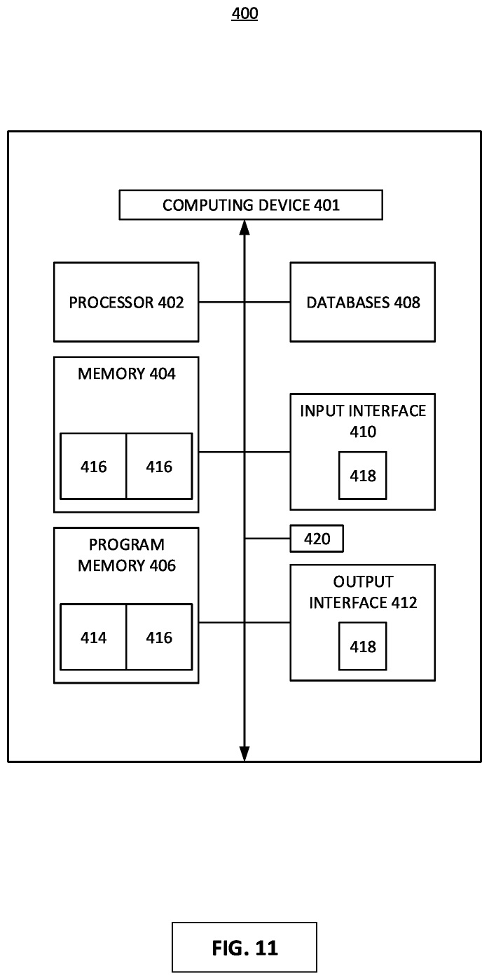

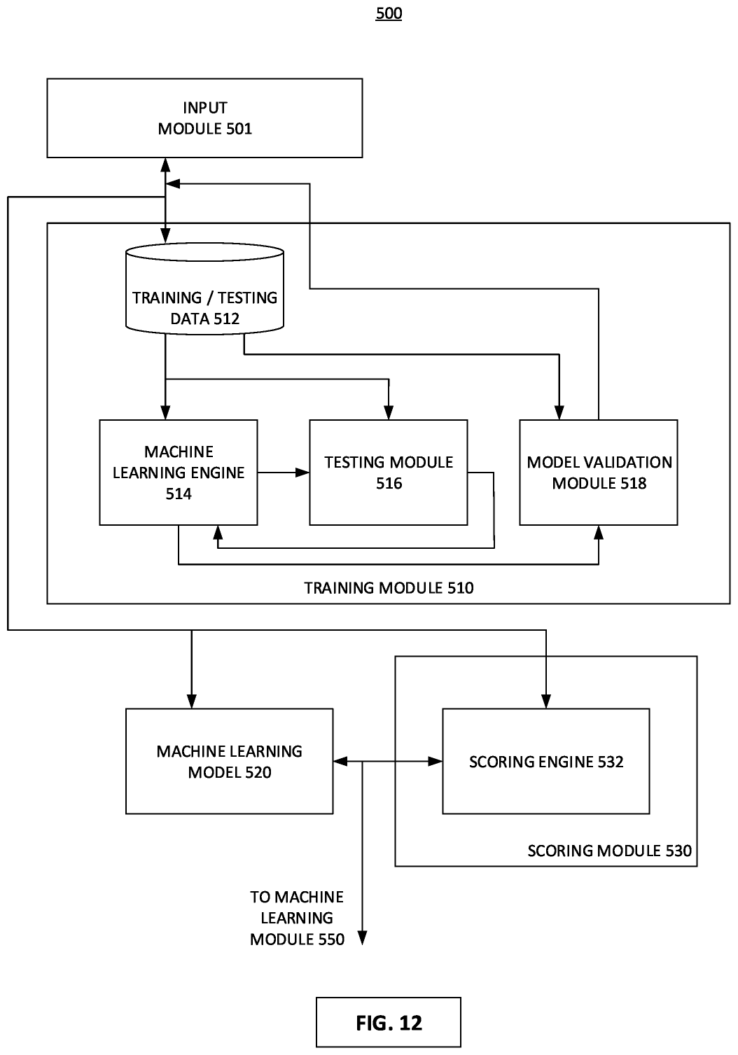

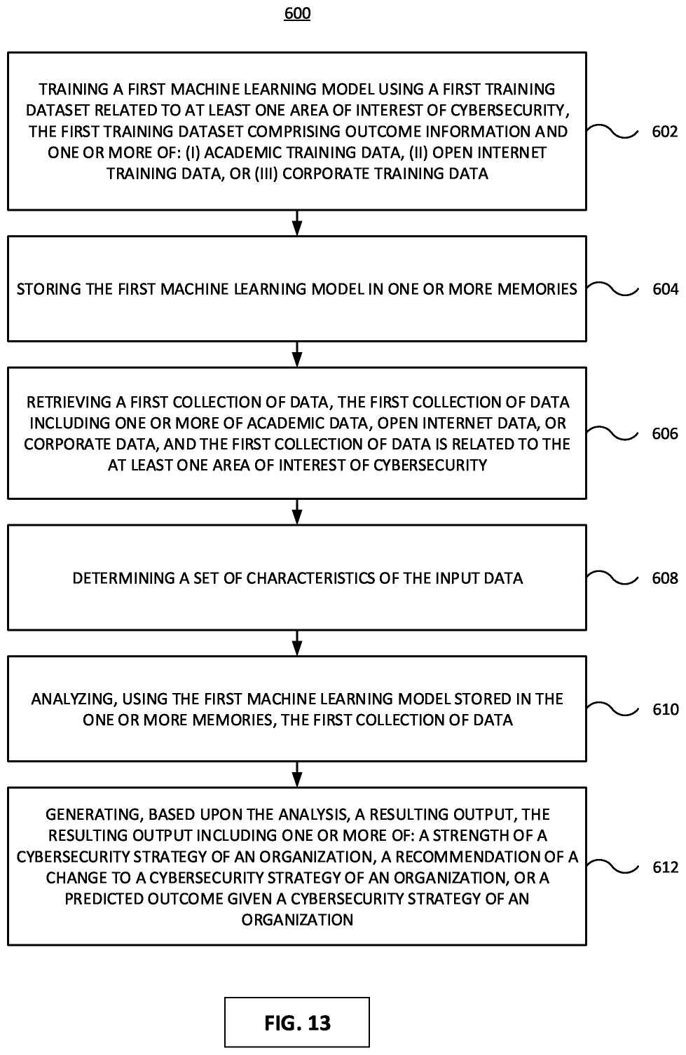

FIG. 10 depicts the CSAM design for leveraging crowdsourced analytic results within a reporting and visualization engine to create cybersecurity strategy recommendations and alerts based on threat trends. Native to the outcome information captured from academic, open internet, and organizational sources may include significant threat data. In addition, threat model domain information may be captured as a part of overall cybersecurity strategy information capture. Each of these sets of cybersecurity threat information may be analyzed within the CSAM analytics engine to create ROI-focused threat alerts targeting strategic cybersecurity program changes.

The analytic algorithms described herein for use within Business Intelligence Engine 302 may involve correlation computations based on simple regression analyses across the multidimensional surfaces from per-domain and cross-domain BP data elements and cybersecurity outcomes as defined in Table 4. This same approach may be used to support correlation analyses of for threat information, resulting in correlation statistics for specific types of cybersecurity threats that correlate with successful attacks given specific previously implemented cybersecurity strategies.

Similarly, as described above, Business Intelligence Engine 302 may use machine learning-based predictive analytics in support of decision modeling. The same process may apply here for threat alert generation. The inputs from the various parameterized threat data sets may be combined with outcome information to train machine learning algorithms on the most likely outcomes that a given threat will trigger given a specific previously implemented cybersecurity strategy. As a result, strategic decisions that are likely to result in negative outcomes may be used to trigger cyber strategy alerts.

Both types of threat-based analytic results may be stored within Crowdsourced Analytic Results 303. Reporting and Visualization Engine 304 may be leveraged to create organized summaries of trends, correlations, and predictions for cybersecurity strategy based on these threat analytics. As previously, direct intervention by human cybersecurity strategy experts may be required to validate and verify applicability and completeness before processing into Strategic Cyber Threat Alerts 14. The completed Strategic Cyber Threat Alerts 14 may be delivered to Threat-Focused Organizations 107 to complete the information lifecycle.

It should be appreciated that the foregoing processes, methods, and/or techniques described herein need not be performed in any specific order and/or need not be performed by specific architecture (e.g., a singular component may be both the Text Mining Engine 204 and the Data Lake 205, more than two data warehouses may be utilized, etc.). Further, processes, methods, and/or techniques calling for iterative, incremental, cyclical, and/or recursive processing techniques may be interchangeably performed by any one or more of iterative, incremental, cyclical, and/or recursive processing where appropriate.

### Exemplary Computing Devices and Systems

FIG. 11 depicts a block diagram of an exemplary computing system 400 to implement any of the foregoing systems, methods, and/or techniques in accordance with described embodiments.

The computing system 400 may include one or more processors 402 (e.g., a programmable processor, a programmable controller, a GPU, a DSP, an ASIC, a PLD, an FPGA, an FPLD, etc.), one or more memories (e.g., random access memory (RAM) 414, read only memory (ROM) 416, cache, etc.) 404, one or more program memories 406, one or more input units 410, and/or one or more output units 412, all of which may be interconnected via an address/data bus 420. The one or more program memories 406 may store software and/or computer-executable instructions, which may be executed by the one or more processors 402.

The one or more program memories 406 may include one or more memories 404 that may store software and/or computer-executable instructions. The software and/or computer-executable instructions may be stored on separate non-transitory computer-readable storage mediums or disks, or at different physical locations.

In some embodiments, the one or more processors 402 may also include, or otherwise be communicatively connected to, one or more databases 408 or other data storage mechanism (one or more hard disk drives, optical storage drives, solid state storage devices, CDs, CD-ROMs, DVDs, Blu-ray disks, etc.). In some examples, the one or more databases 408 store a set of training/testing data.

The one or more input units 410 and/or the one or more output units 412 may include any number of different types of input and/or output units and/or combined I/O circuits and/or components that enable the one or more processors 402 to communicate with peripheral devices. The peripheral devices may be any desired type of device such as a keyboard, a display (a liquid crystal display (LCD), a cathode ray tube (CRT) display, touch, etc.), a navigation device (a mouse, a trackball, a capacitive touch pad, a joystick, etc.), a speaker, a microphone, a button, a communication interface, an antenna, etc. The one or more input units 410 and/or the one or more output units 412 may include any number of different network transceivers 418. The network transceivers 118 may be a Wi-Fi transceiver, a Bluetooth® transceiver, an infrared transceiver, a cellular transceiver, an Ethernet network transceiver, an asynchronous transfer mode (ATM) network transceiver, a digital subscriber line (DSL) modem, a cable modem, etc.

The one or more program memories 106 and/or the one or more memories 404 may be implemented in any known form of volatile or non-volatile computer storage media, including but not limited to, semiconductor memories, magnetically readable memories, and/or optically readable memories, for example, but does not include carrier waves.

As used herein, a non-transitory computer-readable storage medium or disk may be, but is not limited to, one or more of a hard disk drive (HDD), an optical storage drive, a solid-state storage device, a solid-state drive (SSD), a read-only memory (ROM), a random-access memory (RAM), a compact disc (CD), a compact disc read-only memory (CD-ROM), a digital versatile disk (DVD), a Blu-ray disk, a cache, a flash memory, and/or any other storage device or storage disk in which information may be stored for any duration (e.g., permanently, for an extended time period, for a brief instance, for temporarily buffering, for caching of the information, etc.).

It should be appreciated that the computing system 400 may include multiple nodes (computers) comprising of multiple processors 402, multiple memories 404, multiple program memories 406, multiple databases 408, multiple input units 410, and/or multiple output units 412 in the form of computing clusters where a cluster is in the form or one or more of these nodes.

It should be appreciated that while specific elements, components, and/or devices are described as part of computing system 400, other elements, components, and/or devices are contemplated.

### Exemplary Machine Learning Training Module and Scoring Module

FIG. 12 depicts a diagram of an exemplary machine learning training module 500. The machine learning training module 500 may include a training module 510, training/testing data 512, a machine learning engine 514, a testing module 516, a model validation module 518, a machine learning model 520, a scoring module 530, and/or a scoring engine 532.

The training module 510 may include the machine learning engine 514, the testing module 516, and/or the model validation module 518. The training/testing data 512 may store any number of prior multidimensional surfaces from per-domain and cross-domain BP data elements and/or cybersecurity outcomes as defined in Table 4 which may be stored on any number or type(s) of non-transitory machine-readable storage medium or disk using any number or type(s) of data structures. The scoring module 530 may include the scoring engine 532.

The training module 510, the machine learning engine 514, the testing module, 516, the model validation module 518, the machine learning model 520, the scoring module 530, and/or the scoring engine 532, may be, or may include, a portion of a memory unit (e.g., the one or more program memories 406 of FIG. 11) configured to store software and/or computer-executable instructions that, when executed by a processing unit (e.g., the one or more processors 402 of FIG. 11), may cause the one or more of the aforementioned components to generate, develop, train, test, deploy, and/or validate the machine learning model 520 for generating one or more resulting outputs of cybersecurity outcomes. The training module 510, the machine learning model 520 and/or the scoring module 530 may be executed for use as a machine learning module 550. There may be one or more machine learning models 520.

In operation, the input module 501 may initially access the machine learning training module 500. The machine learning training module 500 may form input vectors from the training/testing data 512 and may be passed through the machine learning engine 514 to form test cybersecurity outcomes. Similarly, the machine learning training module 500 may pass prior multidimensional surfaces from per-domain and cross-domain BP data elements and/or cybersecurity outcomes to the testing module 516 and/or to the model validation module 518. The developing machine learning model within the machine learning engine 514 may be trained using supervised learning.

The testing module 516 may compare the resulting outputs of cybersecurity outcomes by the machine learning engine 514 to the actual cybersecurity outcomes of the input training data to determine an error rate that may be used to develop and/or update the machine learning model 520. The machine learning engine 514 may generate, develop, deploy, and/or update the machine learning model 520 by using, for example, gradient boosting machine learning, a neural network, deep learning, a regression technique, etc.

The developing machine learning model within the machine learning engine 514 may be validated by the model validation module 518. The model validation module may statistically validate the developing machine learning model, for example, by using k-fold cross-validation. In these embodiments, the training/testing data 512 may be randomly split into k parts, and the developing machine learning model may be trained using k−1 of the k parts of the training/testing data 512 which represent prior multidimensional surfaces from per-domain and cross-domain BP data elements and/or cybersecurity outcomes.

The developing machine learning model may be evaluated using the remaining one part of the training/testing data 512 which represent the multidimensional surfaces from per-domain and cross-domain BP data elements and/or cybersecurity outcomes, which the machine learning engine 514 has not yet been exposed to. Results of the developing machine learning model for generating resulting outputs of cybersecurity outcomes are compared to the actual cybersecurity outcomes by the model validation module 518 to determine the performance and/or convergence of developing machine learning model. Performance and/or convergence may be determined by, for example, identifying when a metric computed over the previously determined error rate (e.g., a mean-square metric, a rate-of-decrease metric, etc.) satisfies a criteria (e.g., a metric is less than a predetermined threshold, such as a root mean squared error).

The resulting machine learning model 520 may be further evaluated by the scoring module 530. The scoring engine 532 of the scoring module 530 may be used to generate simulated input data from sample data from the training/testing data 512. The simulated input data may include multidimensional surfaces from per-domain and cross-domain BP data elements and/or cybersecurity outcomes, etc.

In some alternative embodiments, the scoring module 530 may develop, deploy, and/or update the machine learning model 520 without the training module 510. In these embodiments, the scoring module 530 uses sample data from the training/testing data 512 to generate a plurality of simulated input data. The input data may be used as the training data and/or the testing data in the development of the machine learning model 520.

The foregoing processes may repeat until the results of the machine learning model 520 produce a desirable error rate. The machine learning model 520 may be updated from parallel machine learning engines 514 and/or scoring engines 532. It should be appreciated that while specific elements, processes, devices, and/or components are described as part of example machine learning training module 500, other elements, processes, devices and/or components are contemplated and/or the elements, processes, devices, and/or components may interact in different ways and/or in differing orders, etc. Additionally, the machine learning models described herein may utilize any artificial intelligence techniques including, but not limited to, such as gradient boosting, neural networks, deep learning, linear regression, polynomial regression, logistic regression, support vector machines, decision trees, random forests, nearest neighbors, and/or any other suitable machine learning technique, some of which are described in more detail herein.

### Exemplary Methods and Processes

FIG. 13 depicts an exemplary computer-implemented method 600 for generating cybersecurity outcomes using automated data capturing and machine learning algorithms. The method 600 depicted in FIG. 13 may employ any of the techniques, methods, and systems described herein with respect to FIGS. 1-12.

The method 600 may begin at block 602 by training, by one or more processors, a first machine learning model using a first training dataset related to at least one area of interest of cybersecurity, the first training dataset comprising outcome information and one or more of: (i) academic training data, (ii) open internet training data, and/or (iii) corporate training data. A machine learning module (e.g., machine learning module 550) may generate a machine learning model based upon training data from previously generated cybersecurity outcomes. The training data may include, for each multidimensional surfaces from per-domain and cross-domain BP data elements and/or cybersecurity outcomes as defined in Table 4.

The machine learning module may test the machine learning model generated. In some embodiments, the test may be conducted using the machine learning technique used to generate the model (e.g., gradient boosting, neural networks, deep learning, linear regression, polynomial regression, support vector machines, decision trees, random forests, nearest neighbors, and/or any other suitable machine learning technique). Further, in some embodiments, the testing data may be from the same collection of data as the training data. In these embodiments, the training data may generate the machine learning model and the testing data may determine the accuracy of the model. When the machine learning module is correct more than a predetermined threshold amount, the machine learning model may be used generating cybersecurity outcomes. However, if the machine learning module is not correct more than the threshold amount, the machine learning module may continue obtaining sets of training data and/or testing data for further training and/or testing.

The method 600 may proceed to block 604 by storing, by the one or more processors, the first machine learning model in one or more memories.

The method 600 may proceed to block 606 by retrieving, by the one or more processors, a first collection of data, the first collection of data including one or more of academic data, open internet data, and/or corporate data, and the first collection of data is related to the at least one area of interest of cybersecurity. As described in detail above, the academic data may include peer-reviewed academic research, the open internet data may include one or more of one or more news sources, one or more blogs, one or more forum posts, and/or one or more social media sources, and the corporate data may include one or more of anonymized corporate data and/or attributed corporate data. Any of the first collection of data may be collected by the Data Retrieval Engine 203 and/or the Web Portal 207. Further, any of the first collection of data may be retrieved manually and/or automatically (e.g., by using artificial intelligence techniques and/or algorithms). In addition, the area of interests of cybersecurity may include one or more of: ransomware attacks, denial of service attacks, social engineering attacks, password attacks, cloud attacks, near misses, and/or threat trends

The method 600 may proceed to block 608 by analyzing, by the one or more processors using the first machine learning model stored in the one or more memories, the first collection of data. Analysis of data described herein may include one or more of descriptive analysis algorithms, predictive analysis algorithms, and/or statistical modeling algorithms.

The method 600 may proceed to block 610 by generating, by the one or more processors based upon the analysis, a resulting output, the resulting output including one or more of: a strength of a cybersecurity strategy of an organization, a recommendation of a change to a cybersecurity strategy of an organization, or a predicted outcome given a cybersecurity strategy of an organization. This resulting output may then be further processed (e.g., visualization data may be generated, etc.) and/or may be provided to one or more Cyber Support Organizations 104, Threat-focused Organizations 107, Corporate Cyber Practitioners 105, and/or Government Cyber Decision Makers 106.

The method 600 may have more or less or different steps and/or may be performed in different orders of steps. For example, the method 600 may also include (i) training, by the one or more processors, a second machine learning model using a second training dataset related to at least one area of interest of cybersecurity, the second training dataset comprising outcome information and one or more of: (a) the academic training data, (b) the open internet training data, and/or (c) the corporate training data; (ii) storing, by the one or more processors, the second machine learning model in the one or more memories; (iii) identifying, by the one or more processors using the second machine learning model stored in the one or more memories, a second collection of data, the second collection of data including one or more of academic data, open internet data, and/or corporate data, and the second collection of data is related to the at least one area of interest of cybersecurity; (iv) reducing, by the one or more processors, the percent rate of error of generating the resulting output by calculating one or more of: (a) the ordinary least squares of the difference between the generated resulting output and the actual resulting output of the first training data set, and/or (b) the ordinary mean square of an aggregation of results between the generated resulting output and the actual resulting output of the first training data set; and/or (v) generating, by the one or more processors, a confidence interval based upon one or more of: (a) the generated resulting output, (b) the actual resulting output of the first training data set, and/or (c) one or more standard deviations from the aggregated result.

### Exemplary Best Practice Data Elements Per-Domain

The following set of tables are a non-exhaustive list of data elements that may be used throughout various aspects of this description. Note that the following detailed per-domain best practice data elements are designed to change and grow, adapting to the changing nature of cybersecurity best practices and the iteratively discovered best approaches to identify and parameterize cybersecurity strategy.

TABLE A1
Domain Information Element—Program Administration and Planning

| Domain | |
|---|---|
| Information Element | Data Type |
| Cybersecurity Leadership | Categorical: CISO, IT Manager, vCISO, |
| | Infrastructure Manager, Director of IT, |
| | Cybersecurity Manager, None. |
| Cybersecurity | Categorical: Dedicated, Mixed IT/Cyber, |
| Management Team | Mixed IT/Executive, Mixed Cyber/ |
| | Executive, None. |
| Cybersecurity Management | Numeric |
| Team Size | |
| Cybersecurity Management | Numeric |
| Team Cadence | |
| (meetings per week) | |
| Cybersecurity Management | Percentage |
| Outsourcing | |
| Cybersecurity Team | Percentage |
| Outsourcing | |
| Cybersecurity Team | Categorical: General Technical, General |
| Outsourcing Type | Managerial, Domain-Specific |
| | (per domain list) |
| Breach Insurance | Categorical: Internal, External, Mixed |
| Management | |
| Program External Audit | Yes/No |
| Program External | Numeric |
| Audit Cadence | |
| (minimum times per year) | |
| Compliance Aspects | Categorical: NIST, HIPAA, PCI, |
| Managed | ISO, COBIT, CIS, FinTech, SEC, |
| | COSO, GDPR, CPRA, other. |
| Governance, Risk, and/or | Percentage |
| Compliance Alignment | |
| Cyber Policy | Percentage |
| Alignment (based on | |
| domain cyber coverage) | |
| Policy Review Cadence | Numeric |
| (minimum times per year) | |
| Policy Approval Type | Categorical: Security Committee, |
| | Approval Committee, |
| | Risk Committee, Executive |
| | Team, Management Sub-team, other. |
| Policy Approval Level | Categorical: Domain Dependent, |
| | CIO, CIO+, CISO, IT |
| | Manager, vCISO, Infrastructure |
| | Manager, Director of IT, Cybersecurity |
| | Manager, None. |
| Cyber Procedure | Percentage |
| Alignment (based on | |
| domain cyber coverage) | |
| Procedure Review Cadence | Numeric |
| (minimum times per year) | |
| Procedure Approval Level | Categorical: Domain Dependent, |
| | CIO, CIO+, CISO, IT Manager, |
| | vCISO, Infrastructure |
| | Manager, Director of IT, Cybersecurity |
| | Manager, None. |

TABLE A2
Domain Information Elements—Policies,
Plans, and Procedures Management

| Domain Information Element | Data Type |
|---|---|
| Cybersecurity Policy Structure | Categorical: Omnibus, Per-domain, |
| | Blended |
| Cybersecurity Procedure/Plan | Categorical: Omnibus, Per-domain, |
| Structure | Blended |
| Cyber PPP Confidence Level | Percentage |
| Policy Strength Domains | Categorical (based on cyber domains) |
| Policy Weakness Domains | Categorical (based on cyber domains) |
| Policy Highest Churn | Categorical (based on cyber domains) |
| Policy Least Churn | Categorical (based on cyber domains) |
| Procedure/Plan Strength | Categorical (based on cyber domains) |
| Domains | |
| Procedure/Plan Weakness | Categorical (based on cyber domains) |
| Domains | |
| Procedure/Plan Highest Churn | Categorical (based on cyber domains) |
| Procedure/Plan Least Churn | Categorical (based on cyber domains) |
| Policy Gaps | Categorical (based on cyber domains) |
| Procedure/Plan Gaps | Categorical (based on cyber domains) |

TABLE A3
Domain Information Elements—Identity and Access Management

| Domain Information Element | Data Type |
|---|---|
| IAM Policy Defined | Yes/No |
| IAM Policy Coverage Level | Percentage |
| Central IAM Solution In Place | Yes/No |
| MFA, Critical System Coverage | Percentage |
| MFA, Overall System Coverage | Percentage |
| Account Audit/Review Cadence (per year) | Numeric |
| HR Integration Confidence Level | Percentage |
| Least Privilege Controls In Place | Yes/No |
| PAM Access Controls in Place | Yes/No/Partial |
| PAM Access Confidence Level | Percentage |
| Endpoint Local Admin Restricted | Yes/No/Partial |
| Default Cloud Super-User Accounts Disabled | Yes/No/Partial |
| User Permissions Removal Confidence Level | Percentage |
| Temporary Access Management Controls in | Yes/No |
| Place | |
| Temporary Access Management Confidence | Percentage |
| Level | |
| Separation of Duties in Place | Yes/No/Partial |
| Separation of Duties Confidence Level | Percentage |
| Account Creation/Deletion Confidence Level | Percentage |
| RBAC Coverage | Percentage |
| Access Logging Coverage | Percentage |
| Shared Access Allowed | Yes/No |
| Shared Access Confidence Level | Percentage |
| Password Strength Rating | Categorical |
| | (weak, moderate, |
| | strong, very strong) |
| Policy Exceptions Allowed (per year) | Numeric |
| Single Sign-On Access in Place | Yes/No |
| Single Sign-On Business Systems Coverage | Percentage |
| Policy Compliance Violations (per year) | Numeric |

TABLE A4
Domain Information Elements—Endpoint Protection

| Domain Information Element | Data Type |
|---|---|
| Endpoint Protection (EP) Policy Defined | Yes/No |
| EP Policy Coverage Level | Percentage |
| Central EP Solution in Place | Yes/No |
| Endpoint Detection & Response (EDR) in | Yes/No |
| Place | |
| EDR Integrated with Perimeter/MDR | Yes/No |
| Controls | |
| Third Party EDR Service in Place | Yes/No |
| USB/Peripheral Storage Controls in Place | Yes/No |
| USB/Peripheral Storage Smays in Place | Yes/No |
| Browser/Internet Threat Controls in Place | Yes/No |
| Mobile Code Threat Controls in Place | Yes/No |
| Full Smay Cadence (times per day) | Numeric |
| Partial Smay Cadence (times per day) | Numeric |
| Signature/Threat Update Cadence | Numeric |
| (times per day) | |
| Endpoint OS Types | Categorical (Windows, |
| | Linux, Macs, etc.) |
| Endpoint OS Percentages | Percentages per Type |
| Aging Endpoints | Percentage |
| Endpoint Protection Configuration Review | Numeric |
| Cadence (minimum times per year) | |

TABLE A5
Domain Information Elements—Perimeter/Cloud Protection

| Domain Information Element | Data Type |
|---|---|
| Perimeter Protection (PP) Policy Defined | Yes/No |
| PP Policy Coverage Level | Percentage |
| Integrated PP Solution in Place | Yes/No |
| Perimeter/Managed Detection & Response in | Yes/No |
| Place | |
| MDR Integrated with Endpoint/EDR Controls | Yes/No |
| NGFW(s) in Place | Yes/No |
| Web Application Firewalls (WAF) in Place | Yes/No/Not Applicable |
| DMZ(s) in Place | Yes/No/Not Applicable |
| Cloud DMZ(s) in Place | Yes/No/Not Applicable |
| Third-Party/MSP PP Support | Yes/No |
| PP Configuration Review Cadence | Numeric |
| (minimum times per year) | |
| Cloud Configuration Review Cadence | Numeric |
| (minimum times per year) | |

TABLE A6
Domain Information Elements—Network Security

| Domain Information Element | Data Type |
|---|---|
| Network Security (NS) Policy Defined | Yes/No |
| NS Policy Coverage Level | Percentage |
| Integrated NS Solution in Place | Yes/No |
| Third Party NS and/or IDS/IPS Service in | Yes/No |
| Place | |
| IDS/IPS Controls in Place | Yes/No |
| ISD/IPS Centrally Managed | Yes/No |
| Physical Connection Controls in Place | Yes/No |
| Network Segmentation in Place | Yes/No |
| Number of Operating Segments | Numeric |
| NS Configuration Review Cadence | Numeric |
| (minimum times per year) | |

TABLE A7
Domain Information Elements—Risk Management

| Domain Information Element | Data Type |
|---|---|
| Cyber Risk Management (RM) Policy | Yes/No |
| Defined | |
| RM Policy Coverage Level (domains | Percentage |
| coverage) | |
| Relative Compliance Burden | Percentage |
| Risk Register Maintained | Yes/No |
| Risk Register Domain Coverage | Percentage |
| Risk Register Confidence Level | Percentage |
| Enterprise Risk Alignment | Percentage |
| Plan of Action & Milestones/Action | Yes/No |
| Plans Tracked | |
| Risk Register Review Cadence | Numeric/Not applicable |
| (minimum times per year) | |

TABLE A8
Domain Information Elements—Training

| Domain Information Element | Data Type |
|---|---|
| Cybersecurity Training (CT) Policy Defined | Yes/No |
| CT Policy Coverage Level | Percentage |
| CT Training Cadence—Staff | Numeric |
| (minimum times per year) | |
| CT Training Cadence—IT | Numeric |
| (minimum times per year) | |
| Customized Training | Percentage |
| General Cyber Training Solution in Place | Yes/No |
| General Cyber Testing Solution in Place | Yes/No |
| Phishing Training Solution/Service in Place | Yes/No |
| Phishing Testing Solution/Service in Place | Yes/No |
| General Cyber Awareness Confidence Level | Percentage |
| Phishing/Social Engineering Confidence | Percentage |
| Level | |
| Executive Training in Place | Yes/No |
| Executive Training Cadence | Numeric/Not applicable |
| (minimum times per year) | |
| Key Person Training in Place | Yes/No |
| Key Person Training Cadence | Numeric/Not applicable |
| (minimum times per year) | |
| Privileged Access Management Training in | Yes/No |
| Place | |
| Privileged Access Management Training | Numeric/Not applicable |
| Cadence (minimum times per year) | |
| General Data Governance Training in Place | Yes/No |
| General Data Governance Training Type | Integrated/Standalone/ |
| | Custom/Not applicable |
| Insider Threat Training in Place | Yes/No |
| Insider Threat Training Type | Integrated/Standalone/ |
| | Custom/Not applicable |
| Staff Incident Response (IR) Training in | Yes/No |
| Place | |
| Staff IR Training Cadence | Yes/No |
| (minimum times per year) | |
| Staff IR Training Type | Integrated/Standalone/ |
| | Custom/Not applicable |
| Whistleblower Training in Place | Yes/No |
| Work-from-Home Training in Place | Yes/No/Not applicable |
| Work-while-Traveling Training in Place | Yes/No/Not applicable |
| CT Compliance/Efficacy Review Cadence | Numeric/Not applicable |
| (minimum times per year) | |

TABLE A9
Domain Information Elements—Data Governance

| Domain Information Element | Data Type |
|---|---|
| Data Governance (DG) Policy Defined | Yes/No |
| DG Policy Coverage Level | Percentage |
| DG Committee Established | Yes/No |
| DG Committee Operating Cadence | Numeric/Not |
| (minimum times per year) | applicable |
| Data Classes | Numeric |
| Data Protection Defined by Class | Yes/No |
| Data Protection Confidence Level | Percentage |
| Data Retention Plan in Place | Yes/No |
| Data Retention Plan Compliance | Percentage |
| Data Loss Prevention Solution in Place | Yes/No |
| Encryption-at-Rest | Yes/No |
| Encryption-at-Rest Compliance | Percentage |
| Encryption-in-Motion | Yes/No |
| Encryption-in-Motion Compliance | Percentage |
| Enterprise Data Model Defined | Yes/No |
| Enterprise Data Model Confidence Level | Percentage |
| Data Ownership Confidence Level | Percentage |
| Data Definition Confidence Level | Percentage |
| DG Compliance/Efficacy Review Cadence | Numeric/Not |
| (minimum times per year) | applicable |

TABLE A10
Domain Information Elements—Email and Communications

| Domain Information Element | Data Type |
|---|---|
| Email & Comms Cybersecurity (EC) Policy | Yes/No |
| Defined | |
| EC Policy Coverage Level | Percentage |
| Email & Communication Acceptable Use | Yes/No |
| Policy (AUP) Defined | |
| AUP Sign-off | Yes/No |
| AUP Recertification Cadence (minimum | Numeric |
| times per year) | |
| Social Media AUP Defined | Yes/No |
| Whistleblower Policy Defined | Yes/No |
| Incident Reporting Policy Defined | Yes/No |
| Incident Reporting Procedures Defined | Yes/No |
| Incident Reporting Executive Policy Defined | Yes/No |
| EC Compliance/Efficacy Review Cadence | Numeric/Not |
| (minimum times per year) | applicable |

TABLE A11
Domain Information Elements—Secure Business Continuity

| Domain Information Element | Data Type |
|---|---|
| Secure Business Continuity (SBC) Policy | Yes/No |
| Defined | |
| SBC Policy Coverage Level | Percentage |
| General Business Continuity (BC) Policy | Yes/No |
| Defined | |
| General BC Policy Coverage Level | Percentage |
| Business Impact Analysis Complete | Yes/No |
| BIA Security Impacts Defined | Yes/No |
| BIA Security Confidence Level | Percentage |
| BIA Review Cadence (minimum times per | Numeric |
| year) | |
| SBC/BC Testing Requirements Defined | Yes/No |
| SBC/BC Testing Cadence (minimum times | Numeric |
| per year) | |
| SBC/BC Testing Types | Categorical (Tabletop/ |
| | Live/Simulated/Textual/ |
| | Not applicable) |
| SBC/BC Test Integrations | Categorical (IR Plan/DR |
| | Plan/Email & Comms/ |
| | Other/Not applicable) |
| SBC/BC Alignment with IR/DR Plans | Yes/No |
| Established | |
| SBC/BC Alignment with IR/DR Plans | Percentage |
| Confidence Level | |
| SBC/BC Compliance/Efficacy Review | Numeric/Not applicable |
| Cadence (minimum times per year) | |

TABLE A12
Domain Information Elements—Executive/Key Person Cybersecurity

| Domain Information Element | Data Type |
|---|---|
| Executive/Key Person Cyber (EKPC) Policy | Yes/No |
| Defined | |
| EKPC Policy Coverage Level | Percentage |
| Executive Cybersecurity Reviews/Audits | Yes/No |
| Executive Cybersecurity Review/Audit | Numeric |
| Cadence (minimum times per year) | |
| Executive Personal Cybersecurity Included | Yes/No |
| Executive Cyber Review Source | Categorical (Internal |
| | Staff/Third-Party |
| | Provider) |
| Executive Cyber Confidence Level | Percentage |
| Key Person Cybersecurity Reviews/Audits | Yes/No |
| Key Person Cybersecurity Review/Audit | Numeric |
| Cadence (minimum times per year) | |
| Key Person Personal Cybersecurity Included | Yes/No |
| Key Person Cyber Review Source | Categorical (Internal |
| | Staff/Third-Party |
| | Provider) |
| Key Person Cyber Confidence Level | Percentage |
| EKPC Compliance/Efficacy Review Cadence | Numeric/Not |
| (minimum times per year) | applicable |

TABLE A13
Domain Information Elements—IT Disaster Recovery

| Domain Information Element | Data Type |
|---|---|
| IT Disaster Recovery (DR) Policy Defined | Yes/No |
| DR Policy Coverage Level | Percentage |
| Backup Types in Use | Categorical (On-prem, |
| | Cloud, Hybrid, |
| | Appliance) |
| Backup Management | Categorical (Internal, |
| | Third-Party) |
| Backup Hardening in Place | Yes/No |
| Backup Hardening Confidence Level | Percentage |
| Air Gapped Backups Maintained | Yes/No |
| Levels of Critical Data Redundancy | Numeric |
| Server Restore Test Cadence (minimum | Numeric |
| times per year) | |
| File Restore Test Cadence (minimum times | Numeric |
| per year) | |
| Business System Restore Test Cadence | Numeric |
| (minimum times per year) | |
| Failover Plan in Place | Yes/No |
| Failover Types | Categorical (Remote |
| | Site, Cloud, Colo, |
| | Appliance, Third-Party) |
| Failover System Coverage | Percentage |
| Failover Hardening in Place | Yes/No |
| Failover Hardening Confidence Level | Percentage |
| Failover Testing Cadence (minimum times | Numeric |
| per year) | |
| General Failover RTO (hours) | Numeric |
| Critical Systems Failover RTO (hours) | Numeric/Not applicable |
| General Failure RPO (hours) | Numeric |
| Critical Systems Failure RPO (hours) | Numeric |
| IT DR Compliance/Efficacy Review | Numeric/Not applicable |
| Cadence (minimum times per year) | |

TABLE A14
Domain Information Elements—Vulnerability Management

| Domain Information Element | Data Type |
|---|---|
| Vulnerability Management (VUM) Policy | Yes/No |
| Defined | |
| VUM Policy Coverage Level | Percentage |
| Endpoint Patching Procedures Defined | Yes/No |
| Endpoint OS Patch—Critical Patches (hours) | Numeric |
| Endpoint OS Patching via Centralized Tool(s) | Yes/No |
| Endpoint OS Patch Testing | Yes/No |
| Endpoint OS Patch Testing Confidence Level | Percentage |
| Endpoint Third-Party App Patching via | Yes/No |
| Centralized Tools | |
| Endpoint Third-Party App Patch Coverage | Percentage |
| Endpoint Third-Party App Patching | Percentage |
| Confidence Level | |
| Endpoint Third-Party App Patch—Critical | Numeric |
| Patches (hours) | |
| Endpoint Third-Party App Patch Testing | Yes/No |
| Endpoint Third-Party App Patch Testing | Percentage |
| Confidence Level | |
| Server OS Patch- Critical Patches (hours) | Numeric |
| Server OS Patch Testing | Yes/No |
| Server OS Patch Testing Confidence Level | Percentage |
| Server OS Patching via Centralized Tool(s) | Yes/No |
| Server Third-Party App Patching via | Yes/No |
| Centralized Tools | |
| Server Third-Party App Patching Coverage | Percentage |
| Server Third-Party App Patching Confidence | Percentage |
| Level | |
| Server Third-Party App Patch—Critical | Numeric |
| Patches (hours) | |
| Server Third-Party App Patch Testing | Yes/No |
| Server Third-Party App Patch Testing | Percentage |
| Confidence Level | |
| Vulnerability Smayning | Yes/No |
| Vulnerability Smayning Coverage | Percentage |
| Vulnerability Smayning Type | Categorical (On-prem, |
| | Cloud-based, Third- |
| | party service) |
| Vulnerability Remediation Procedures in | Yes/No |
| Place | |
| Vulnerability Remediation Requirement— | Numeric/Not |
| Critical Vulnerabilities (hours) | applicable |
| Vulnerability Remediation Confidence Level | Percentage |
| Penetration Testing Cadence—Internal | Numeric |
| (minimum times per year) | |
| Penetration Testing Cadence—External | Numeric |
| (minimum times per year) | |
| Penetration Testing Compliance/Efficacy | Numeric/Not |
| Review Cadence (minimum times per year) | applicable |
| Patch Management Compliance/Efficacy | Numeric/Not |
| Review Cadence (minimum times per year) | applicable |

TABLE A15
Domain Information Elements—Incident Response

| Domain Information Element | Data Type |
|---|---|
| Incident Response (IR) Policy Defined | Yes/No |
| IR Policy Coverage Level | Percentage |
| IR Plan Defined | Yes/No |
| IR Runbooks Defined | Yes/No |
| IR Plan Confidence Level | Percentage |
| IR Runbooks Confidence Level | Percentage |
| IR Testing Cadence (minimum times per | Numeric |
| year) | |
| IR Testing Types | Categorical |
| | (Tabletop/Live/ |
| | Simulated/Textual/Not |
| | applicable) |
| IR Plan/Breach Insurance Integration Level | Percentage |
| Forensic Investigation Capability | Yes/No |
| Defined/Acquired | |
| Third-Party IR Support Defined/Acquired | Yes/No |
| Incident Severity Classification Defined | Yes/No |
| Incident Logging Procedures Defined | Yes/No/Partial |
| SOAR Capabilities Implemented | Yes/No |
| IR Compliance/Efficacy Review Cadence | Numeric/Not applicable |
| (minimum times per year) | |

TABLE A16
Domain Information Elements—Mobile Device Management

| Domain Information Element | Data Type |
|---|---|
| Mobile Device Management (MDM) Policy | Yes/No |
| Defined | |
| MDM Policy Coverage Level | Percentage |
| Company-owned Mobiles Usage | Percentage |
| BYOD Mobile Usage | Percentage |
| Centralized MDM Solution in Place | Yes/No |
| Remote Wipe Supported | Yes/No/Partial |
| Geolocation Supported | Yes/No/Partial |
| Email-only MDM Solution in Place | Yes/No/Partial |
| Mobile Application Management in Place | Yes/No/Partial |
| Laptop MDM Controls in Place | Yes/No/Partial |
| MDM Compliance/Efficacy Review Cadence | Numeric/Not |
| (minimum times per year) | applicable |

TABLE A17
Domain Information Elements—Change and Configuration Management

| Domain Information Element | Data Type |
|---|---|
| Change and Configuration Management | Yes/No |
| (CCM) Policy Defined | |
| CCM Policy Coverage Level | Percentage |
| Change Management Procedures Defined | Yes/No/Partial |
| Change Advisory Board Type | Categorical (Virtual, |
| | Live, Mixed, Text/ |
| | List-based) |
| Centralized Change Tracking Tool in Place | Yes/No/Partial |
| Risk-based Change Tracking in Place | Yes/No/Partial |
| Change Testing | Yes/No/Conditional |
| Change Management Confidence Level | Percentage |
| Change Detection Tools in Place | Yes/No/Partial |
| Configuration Backups | Yes/No/Partial |
| Configuration Backup Cadence (minimum | Numeric |
| times per month) | |
| Centralized Config Backup Tool(s) in Place | Yes/No/Partial |
| Endpoint Baseline Config Maintained | Yes/No |
| Endpoint Baseline Config Hardening | Percentage |
| Confidence Level | |
| Server Config Baseline Maintained | Yes/No |
| Server Baseline Config Hardening | Percentage |
| Confidence Level | |
| CCM Compliance/Efficacy Review Cadence | Numeric/Not applicable |
| (minimum times per year) | |

TABLE A18
Domain Information Elements—Physical Cybersecurity

| Domain Information Element | Data Type |
|---|---|
| Physical Cybersecurity (PC) Policy Defined | Yes/No |
| PC Policy Coverage Level | Percentage |
| On-Premise Equipment Access Controls in | Yes/No/Partial |
| Place | |
| On-Premise Equipment Video Monitoring in | Yes/No/Partial |
| Place | |
| On-Premise Physical Security Audit Cadence | Numeric |
| (minimum times per year) | |
| On-Premise Equipment Intrusion Alarms in | Yes/No/Partial |
| Place | |
| Colo/Remote Site Physical Security Audit | Numeric |
| Cadence (minimum times per year) | |
| Colo/Remote Site Equipment Access Controls | Yes/No/Partial |
| in Place | |
| Colo/Remote Site Equipment Video | Yes/No/Partial |
| Monitoring in Place | |
| Colo/Remote Site Equipment Intrusion | Yes/No/Partial |
| Alarms in Place | |
| Endpoint Clear Screen Controls in Place | Yes/No/Partial |
| Clear Desk Review & Enforcement in Place | Yes/No/Partial |
| Facility Electronic Access Controls in Place | Yes/No/Partial |
| Facility Human-based Access Controls in | Yes/No/Partial |
| Place | |
| Facility Alarms in Place | Yes/No/Partial |
| Facility Video Monitoring in Place | Yes/No/Partial |
| Work-from-Home Security Audit/Review in | Yes/No/Partial |
| Place | |
| Work-while-Traveling Security Audit/Review | Yes/No/Partial |
| in Place | |
| PC Compliance/Efficacy Review Cadence | Numeric/Not |
| (minimum times per year) | applicable |

TABLE A19
Domain Information Elements—IT Asset Management

| Domain Information Element | Data Type |
|---|---|
| IT Asset Management (ITAM) Policy | Yes/No |
| Defined | |
| Hardware-Specific ITAM Requirements | Yes/No |
| Defined | |
| Software-Specific ITAM Requirements | Yes/No |
| Defined | |
| ITAM Policy Coverage Level | Percentage |
| ITAM Policy Coverage Level | Percentage |
| Hardware Inventory Maintained | Yes/No/Partial |
| Hardware Inventory Reconciliation Cadence | Numeric |
| (minimum times per year) | |
| Hardware Inventory Confidence Level | Percentage |
| Software Inventory Maintained via | Yes/No/Partial |
| Centralized Tool | |
| Software Inventory Confidence Level | Percentage |
| Software Licensing Centrally Tracked | Yes/No/Partial |
| Hardware Age Tracked | Yes/No/Partial |
| Hardware Acquisition Risk Review Procedure | Yes/No |
| Defined | |
| Software Acquisition Risk Review Procedure | Yes/No |
| Defined | |
| ITAM Compliance/Efficacy Review Cadence | Numeric/Not |
| (minimum times per year) | applicable |

TABLE A20
Domain Information Elements—Monitoring and Log Management

| Domain Information Element | Data Type |
|---|---|
| Monitoring and Log Management (MLM) | Yes/No |
| Policy Defined | |
| MLM Policy Coverage Level | Percentage |
| Centralized Monitoring/MDR Tool in Place | Yes/No |
| Centralized Monitoring via Third-Party | Yes/No |
| Service | |
| SOC Type | Categorical (Internal/Third- |
| | Party/Mixed/None) |
| Dedicated SOC Personnel | Numerical/Not applicable |
| SIEM Capability in Place | Yes/No |
| SIEM Service/Third-Party in Place | Yes/No/Not applicable |
| SIEM Log Retrieval and processing Coverage | Percentage |
| Manual Log Correlation Procedures Defined | Yes/No/Partial |
| MLM/IR/DR Coordination Documented | Yes/No/Partial |
| SIEM-as-a-Service SLAs Cleary Defined | Yes/No/Partial |
| SOC-as-a-Service SLAs Clearly Defined | Yes/No/Partial |
| MDR SLAs Clearly Defined | Yes/No/Partial |
| SIEM Overall Confidence Level | Percentage/Not applicable |
| SOC Overall Confidence Level | Percentage/Not applicable |
| Monitoring/MDR Confidence Level | Percentage/Not applicable |
| MLM Compliance/Efficacy Review Cadence | Numeric/Not applicable |
| (minimum times per year) | |

TABLE A21
Domain Information Elements—Vendor Management

| Domain Information Element | Data Type |
|---|---|
| Vendor Management (VNM) Policy Defined | Yes/No |
| VNM Policy Coverage Level | Percentage |
| VNM Procedures Defined | Yes/No |
| Vendor Inventory Maintained | Yes/No/Partial |
| Vendor Inventory Completeness Estimate | Percentage |
| Vendors Tiered by Relative Cyber Risk | Yes/No/Partial |
| VNM Managed by Third-Party Service | Yes/No |
| VNM Managed via Third-Party Tool(s) | Yes/No |
| Due Diligence Evaluations | Yes/No |
| Onboarding Risk Evaluation | Yes/No |
| Ongoing Monitoring | Yes/No |
| Monitoring Frequency (minimum times per | Numeric |
| year) | |
| Offboarding Risk Evaluation | Yes/No |
| VNM Execution Confidence Level | Percentage |
| VNM Compliance/Efficacy Review Cadence | Numeric/Not |
| (minimum times per year) | applicable |

TABLE A22
Domain Information Elements—Secure Application Development

| Domain Information Element | Data Type |
|---|---|
| Secure Application Development (SAD) | Yes/No |
| Policy Defined | |
| SAD Policy Coverage Level | Percentage |
| Strict SDLC Governance/Controls in Place | Yes/No/Partial |
| Automated SDLC Governance/Controls in | Yes/No/Partial |
| Place | |
| App-Specific Threat & Attack Models | Yes/No/Partial |
| Documented | |
| App-Specific Threat & Attack Models | Yes/No/Partial |
| Integrated into Dev/Test Processes | |
| Threat Model Confidence Level | Percentage |
| Per-Application Security Requirements | Yes/No/Partial |
| Defined | |
| Peer Code Reviews | Yes/No/Partial |
| Application Vulnerability Testing | Yes/No/Partial |
| Application Vulnerability Testing Confidence | Percentage |
| Level | |
| Cybersecurity Expertise Embedded in | Yes/No/Partial |
| AppDev | |
| IV&V | Yes/No/Partial |
| Static Code Reviews | Yes/No/Partial |
| Dynamic Code Reviews | Yes/No/Partial |
| AppDev Risk Management Procedures in | Yes/No |
| Place | |
| Application Penetration Testing | Yes/No/Partial |
| Application Penetration Testing Confidence | Percentage |
| Level | |
| Separation of Duties Enforced | Yes/No/Partial |
| Production Access Restricted | Yes/No |
| SAD Compliance/Efficacy Review Cadence | Numeric/Not |
| (minimum times per year) | applicable |

TABLE A23
Domain Information Elements—Threat Model

| Domain Information Element | Data Type |
|---|---|
| Threat Modeling Policy Defined | Yes/No/Partial |
| TM Policy Coverage Level | Percentage |
| TM Procedure Defined | Yes/No/Partial |
| Internal TM Specifics Included | Yes/No/Partial |
| External TM Specific Included | Yes/No/Partial |
| TM Overall Confidence Level | Percentage/Not applicable |
| TM Review and Update Cadence | Numeric |
| (min times per year) | |

### Additional Considerations

The detailed description is to be construed as exemplary only and does not describe every possible embodiment since describing every possible embodiment would be impractical. Numerous alternative embodiments may be implemented, using either current technology or technology developed after the filing date of this application, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

Some embodiments of the disclosure relate to a non-transitory computer-readable storage medium having instructions/computer-readable storage medium thereon for performing various computer-implemented operations. The term “instructions/one or more computer-readable media” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (“PLDs”), and ROM and RAM devices.

This description provided herein is to be construed as exemplary only and does not describe every possible embodiment, as describing every possible embodiment would be impractical, if not impossible. One may be implement numerous alternate embodiments, using either current technology or technology developed after the filing date of this application. While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations are not necessarily drawn to scale. There may be distinctions between the artistic renditions in the present disclosure and the actual apparatuses and/or systems due to manufacturing processes, tolerances and/or other reasons. There may be other embodiments of the present disclosure which are not specifically illustrated. Modifications may be made to adapt a particular situation, material, composition of matter, technique, or process to the objective, spirit and scope of the present disclosure. All such modifications are intended to be within the scope of the claims appended hereto. While the techniques disclosed herein have been described with reference to particular operations performed in a particular order, it will be understood that these operations may be combined, sub-divided, or re-ordered to form an equivalent technique without departing from the teachings of the present disclosure. Accordingly, unless specifically indicated herein, the order and grouping of the operations are not limitations of the present disclosure.

Those of ordinary skill in the art will recognize that a wide variety of modifications, alterations, and combinations may be made with respect to the above described embodiments without departing from the scope of the invention, and that such modifications, alterations, and combinations are to be viewed as being within the ambit of the inventive concept. The systems and methods described herein are directed to an improvement to computer functionality, and improve the functioning of conventional computers.

1. A computer-implemented method for analyzing cybersecurity data, comprising:
training, by one or more processors, a first machine learning model using a first training dataset related to at least one area of interest of cybersecurity, the first training dataset comprising outcome information and one or more of: (i) academic training data, (ii) open internet training data, or (iii) corporate training data;
storing, by the one or more processors, the first machine learning model in one or more memories;
retrieving, by the one or more processors, a first collection of data, the first collection of data including one or more of academic data, open internet data, or corporate data, and the first collection of data is related to the at least one area of interest of cybersecurity;
analyzing, by the one or more processors using the first machine learning model stored in the one or more memories, the first collection of data; and
generating, by the one or more processors based upon the analysis, a resulting output, the resulting output including one or more of: a strength of a cybersecurity strategy of an organization, a recommendation of a change to a cybersecurity strategy of an organization, or a predicted outcome given a cybersecurity strategy of an organization.

2. The method of claim 1, wherein the first collection of data includes one or more of manually retrieved data or automatically retrieved data.

3. The method of claim 1, wherein the automatically retrieved data is retrieved using one or more artificial intelligence algorithms.

4. The method of claim 1, wherein:
(i) the academic data includes peer-reviewed academic research;
(ii) the open internet data includes one or more of one or more news sources, one or more blogs, one or more forum posts, or one or more social media sources; and
(iii) the corporate data includes one or more of anonymized corporate data or attributed corporate data.

5. The method of claim 1, wherein the first machine learning model includes one or more of a descriptive analysis algorithm or a predictive analysis algorithm.

6. The method of claim 1, further comprising:
analyzing, by the one or more processors using one or more statistical modeling algorithms stored in the one or more memories, the first collection of data.

7. The method of claim 1, wherein the one or more statistical modeling algorithms include a regression model.

8. The method of claim 1, wherein the at least one area of interest of cybersecurity includes one or more of: ransomware attacks, denial of service attacks, social engineering attacks, password attacks, cloud attacks, near misses, or threat trends.

9. The method of claim 1, further comprising:
training, by the one or more processors, a second machine learning model using a second training dataset related to at least one area of interest of cybersecurity, the second training dataset comprising outcome information and one or more of: (i) the academic training data, (ii) the open internet training data, or (iii) the corporate training data;
storing, by the one or more processors, the second machine learning model in the one or more memories; and
identifying, by the one or more processors using the second machine learning model stored in the one or more memories, a second collection of data, the second collection of data including one or more of academic data, open internet data, or corporate data, and the second collection of data is related to the at least one area of interest of cybersecurity.

10. The method of claim 1, wherein:
training the first machine learning model comprises:
reducing, by the one or more processors, the percent rate of error of generating the resulting output by calculating one or more of: (i) the ordinary least squares of the difference between the generated resulting output and the actual resulting output of the first training data set, or (ii) the ordinary mean square of an aggregation of results between the generated resulting output and the actual resulting output of the first training data set; and
generating, by the one or more processors, a confidence interval based upon one or more of: (i) the generated resulting output, (ii) the actual resulting output of the first training data set, and/or (iii) one or more standard deviations from the aggregated result.

11. A computer system for analyzing cybersecurity data, comprising:
one or more processors;
one or more non-transitory program memories coupled to the one or more processors and storing executable instructions that, when executed by the one or more processors, cause the computer system to:
train a first machine learning model using a first training dataset related to at least one area of interest of cybersecurity, the first training dataset comprising outcome information and one or more of: (i) academic training data, (ii) open internet training data, or (iii) corporate training data;
store the first machine learning model in one or more non-transitory program memories;
retrieve a first collection of data, the first collection of data including one or more of academic data, open internet data, or corporate data, and the first collection of data is related to the at least one area of interest of cybersecurity;
analyze, using the first machine learning model stored in the one or more non-transitory program memories, the first collection of data; and
generate, based upon the analysis, a resulting output, the resulting output including one or more of: a strength of a cybersecurity strategy of an organization, a recommendation of a change to a cybersecurity strategy of an organization, or a predicted outcome given a cybersecurity strategy of an organization.

12. The system of claim 11, wherein the first collection of data includes one or more of manually retrieved data or automatically retrieved data.

13. The system of claim 11, wherein the automatically retrieved data is retrieved using one or more artificial intelligence algorithms.

14. The system of claim 11, wherein:
(i) the academic data includes peer-reviewed academic research;
(ii) the open internet data includes one or more of one or more news sources, one or more blogs, one or more forum posts, or one or more social media sources; and
(iii) the corporate data includes one or more of anonymized corporate data or attributed corporate data.

15. The system of claim 11, wherein the first machine learning model includes one or more of a descriptive analysis algorithm or a predictive analysis algorithm.

16. The system of claim 11, wherein the executable instructions, when executed by the one or more processors, further cause the computer system to:
analyze, using one or more statistical modeling algorithms stored in the one or more non-transitory program memories, the first collection of data, the one or more statistical modeling algorithms include a regression model.

17. The system of claim 11, wherein the at least one area of interest of cybersecurity includes one or more of: ransomware attacks, denial of service attacks, social engineering attacks, password attacks, cloud attacks, near misses, or threat trends.

18. The system of claim 11, wherein the executable instructions, when executed by the one or more processors, further cause the computer system to:
train a second machine learning model using a second training dataset related to at least one area of interest of cybersecurity, the second training dataset comprising outcome information and one or more of: (i) the academic training data, (ii) the open internet training data, or (iii) the corporate training data;
store the second machine learning model in the one or more non-transitory program memories; and
identify, using the second machine learning model stored in the one or more non-transitory program memories, a second collection of data, the second collection of data including one or more of academic data, open internet data, or corporate data, and the second collection of data is related to the at least one area of interest of cybersecurity.

19. The system of claim 11, wherein:
training the first machine learning model further causes the computer system to:
reduce the percent rate of error of generating the resulting output by calculating one or more of: (i) the ordinary least squares of the difference between the generated resulting output and the actual resulting output of the first training data set, or (ii) the ordinary mean square of an aggregation of results between the generated resulting output and the actual resulting output of the first training data set; and
generate a confidence interval based upon one or more of: (i) the generated resulting output, (ii) the actual resulting output of the first training data set, and/or (iii) one or more standard deviations from the aggregated result.

20. A tangible, non-transitory computer-readable medium storing executable instructions for predicting the time to replace one or more vehicle seats, the instructions, when executed by one or more processors of a computer system, cause the computer system to:
train a first machine learning model using a first training dataset related to at least one area of interest of cybersecurity, the first training dataset comprising outcome information and one or more of: (i) academic training data, (ii) open internet training data, or (iii) corporate training data;
store the first machine learning model in one or more non-transitory program memories;
retrieve a first collection of data, the first collection of data including one or more of academic data, open internet data, or corporate data, and the first collection of data is related to the at least one area of interest of cybersecurity;
analyze, using the first machine learning model stored in the one or more non-transitory program memories, the first collection of data; and
generate, based upon the analysis, a resulting output, the resulting output including one or more of: a strength of a cybersecurity strategy of an organization, a recommendation of a change to a cybersecurity strategy of an organization, or a predicted outcome given a cybersecurity strategy of an organization.
